(19) United States
(12) Patent Application Publication
(10) Pub. No.: US 2005/0094122 A1
(43) Pub. Date: May 5, 2005

(54) Exposure method and exposure apparatus, light source unit and adjustment method of light source unit, and device manufacturing method

(75) Inventors: Shigeru Hagiwara, Kumagaya (JP); Shinichi Kurita, Ageo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Nikon Corporation, Chiyoda-ku (JP)

(21) Appl. No.: 10/989,340

(22) Filed: Nov. 17, 2004

Related U.S. Application Data
(62) Division of application No. 10/279,849, filed on Oct. 25, 2002, now abandoned.
Application No. 10/279,849 is a continuation-in-part of application No. PCT/JP02/05877, filed on Jun. 13, 2002.

(30) Foreign Application Priority Data
Jun. 13, 2001 (JP) 2001-177878

(51) Int. Cl. G03B 27/72

(52) U.S. Cl. 355/69; 355/67

(57) ABSTRACT

When scanning exposure is performed by illuminating an illumination area on a mask with a pulse light from a pulse light source, synchronously moving the mask and a photosensitive object, and transferring a pattern of the mask onto the photosensitive object, a main controller performs dose control on a high sensitivity range where scanning velocity of the mask and the photosensitive object is set at a maximum so as to maintain an exposure pulse number at a minimum exposure pulse number. A pulse light source, which pulse energy is variable within a predetermined range, maintains the exposure pulse number at the minimum exposure pulse number within the variable range. The pulse light source comprises a housing in which an outgoing opening that emits a light is formed, a plurality of units housed in the housing, and a drive unit that moves the plurality of units, partially or in total inside the housing.

### CROSS-REFERENCE TO RELATED APPLICATIONS

This application is a continuation in-part of international application PCT/JP02/05877, filed Jun. 13, 2002.

### BACKGROUND OF THE INVENTION

1. Field of the Invention

The present invention relates to exposure methods and exposure apparatus, light source units and adjustment methods of light source units, and device manufacturing methods, and more particularly to an exposure method and an exposure apparatus used in a lithographic process when manufacturing devices such as a semiconductor device, a liquid crystal display device, an image pick-up device (such as a CCD), or a thin film magnetic head, a suitable light source for the exposure apparatus and its adjustment method, and a device manufacturing method using both the scanning exposure method and the scanning exposure apparatus.

2. Description of the Related Art

Conventionally, when manufacturing devices such as a semiconductor device, projection exposure apparatus have been used to expose and transfer a pattern of a reticle serving as a mask onto each shot area on a wafer (or glass plate or the like) coated with a photoresist, via a projection optical system.

As such type of an exposure apparatus, a full wafer type projection exposure apparatus such as the stepper has been mainly used, which fully transfers the reticle pattern onto the shot areas on the wafer at once when a wafer stage on which the wafer is mounted is in a stationary state. With such a projection exposure apparatus, dose control is necessary in order to keep total exposure dose (total exposure energy) within a reasonable range with respect to each point in each shot area of the wafer. Therefore, in the full wafer type projection exposure apparatus such as the stepper, cutoff control is basically employed as the dose control method; whether a continuous light source such as an ultra high pressure mercury lamp or a pulse laser light source such as an excimer laser light source is used as the exposure light source. In the cutoff control, while an exposure light is irradiating the wafer coated with the photosensitive material (photoresist), a part of the exposure light is diverged to a photodetector called an integrator sensor, and the dose on the wafer is indirectly detected via the integrator sensor. And in this control, the laser emission is continued until a total value of the detection result exceeds a predetermined level (critical level), which corresponds to the total dose (hereinafter referred to as “set dose”) required by the photosensitive material (when continuous light is used as the light source, a shutter begins to close when the detection result exceeds the critical level).

In recent years, however, in order to allow a pattern in an area larger than before to be transferred with high precision on the wafer without increasing the load on the projection optical system, a scanning type projection exposure apparatus (hereinafter, simply referred to as a “scanning exposure apparatus”) based on a method such as the step-and-scan method is becoming mainstream. With this apparatus, the pattern of the reticle is sequentially transferred onto each shot area of the wafer by synchronously scanning the reticle and the wafer with respect to the projection optical system, while a part of the reticle pattern is being projected on the wafer via the projection optical system.

With this type of exposure apparatus, since dose control focusing on only one point on the wafer cannot be applied, the cutoff control described above cannot be applied. Therefore, in the scanning exposure apparatus, especially in the apparatus that uses a pulse light source as its light source, a dose control method of simply calculating the total of the dose given by each pulse illumination light (open dose control method) was employed as a first control method. In the first control method, in order to obtain linearity in a desired dose control, the pulse energy has to be finely adjusted so that the following relationship will stand; that is, the number of exposure pulse becomes an integral number.
Set Dose (S₀)=Number of Pulse(N)×Average Energy per Pulse(p) (1)

The average energy per pulse p is the value measured by the integrator sensor directly before exposure. Therefore, control parameters (such as the applied voltage) of the pulse light source were adjusted to finely adjust the pulse energy.

Furthermore, when the apparatus uses a pulse light source as its light source, a desired dose control precision is repeatable by performing exposure on a field with a plurality of pulse lights exceeding a constant number (hereinafter, referred to as “minimum exposure pulse number”), due to the energy variation in each pulse.

In the case the apparatus uses a pulse light source such as a laser light source, the following equation also has to be satisfied.
V=Ws/N×f (2)

In the above equation, V is a scanning velocity of the wafer (wafer stage) during scanning exposure, Ws is a width (slit width) of a slit shaped illumination area on the wafer plane in the scanning direction, N is the number of exposure pulse per point, and f is an emission repetition frequency of the pulse light from the light source (hereinafter referred to as “repetition frequency” as appropriate).

In the conventional scanning exposure apparatus, the slit width Ws is normally fixed, and the energy of pulse light on the wafer plane can easily be reduced by attenuation means but cannot be increased exceeding a predetermined value. Therefore, for example, when exposure is performed in a low sensitivity range where a low sensitivity resist is used and a large set dose is required, in order to increase the total energy given per point on the wafer plane during scanning exposure, the repetition frequency f has to be increased or the scanning velocity V decreased. However, the repetition frequency f has limitations due to the light source performance, whereas the scanning velocity V cannot be randomly decreased since such a state will lead to a decrease in throughput. Accordingly, in a low sensitivity range, the scanning velocity V has to be set as fast as possible while maintaining the repetition frequency at a maximum value fₘₐₓ. As a result, however, as it is obvious from the relationship in equation (2), the number of exposure pulse N cannot be maintained at a minimum exposure pulse Nₘᵢₙ.

In addition, when exposure is performed in a high sensitivity range, using a resist with high sensitivity and only a small set dose is required, as it is obvious from equation (1), if the laser beam from the pulse laser light source is used without any modification, exposure which number of pulse exceeds the minimum exposure pulse cannot be performed. Therefore, in such a case when only a small set dose was required, for example, the pulse laser beam was attenuated by attenuation means arranged on the optical path so that exposure which number of pulse exceeds the minimum exposure pulse could be performed.

As the above attenuation means, a rough energy adjuster was used, which was formed of arranging one or more rotatable carousels called a revolver on which a plurality of ND filters having different transmittance (=1—attenuation ratio) were arranged. With this rough energy adjuster, by rotating each of the revolvers, transmittance with respect to the incident pulse light was switched from 100% in a plurality of steps. That is, the transmittance set by the rough energy adjuster was discrete (usually geometrical).

Therefore, especially in a high sensitivity range, it was sometimes difficult to set a corresponding (proportional) attenuation ratio, depending on the set dose. In such a case, there was no other choice but to select the ND filters that produce the closest attenuation ratio corresponding to the set dose from among a combination of ND filters that did not exceed the attenuation ratio corresponding to the set dose. So, the number of exposure pulse N per point was set at a value greater than the minimum exposure pulse Nₘᵢₙ by a discrete amount (the difference from the attenuation ratio corresponding to the ideal set dose set by a continuous variable energy modulator) in the transmittance of ND filters.

As is described so far, in the scanning exposure apparatus using the conventional pulse light source, conditions related to the number of exposure pulse were hardly considered besides the condition of setting the number of exposure pulse so that it exceeds the minimum exposure pulse Nₘᵢₙ from the viewpoint of attaching importance to dose control precision repeatability, when exposing in a low sensitivity range as well as in a high sensitivity range (normally, from the viewpoint of maintaining high throughput, the scanning velocity is maintained at the maximum speed).

Consequently, this caused a waste in pulse consumption, which increased the cost and also led to a shorter life cycle of the pulse light source and the optical system due to degradation. Especially in a pulse light source using a laser gas such as an excimer laser, it also led to an increase in gas consumption.

Recently, due to finer circuit patterns in microdevices such as in a semiconductor integrated circuits, exposure wavelength is becoming shorter, and instead of the conventional emission line (such as an i-line having a wavelength of 365 nm) in the ultraviolet region from the mercury lamp, a KrF excimer laser beam, which is a pulse ultraviolet light having a wavelength of 248 nm is becoming mainstream, and at present, exposure apparatus using an ArF excimer laser beam (wavelength: 193 nm) having a shorter wavelength as its exposure light is entering the practical usage stage. In addition, for the purpose of further shortening the exposure light wavelength, usage of lasers emitting light belonging to the vacuum ultraviolet region having the wavelength of around 120 nm to around 180 nm such as a halogen molecule laser like a fluorine dimer laser (F₂ laser) having an oscillation wavelength of 157 nm is now being explored.

Light source units emitting these kinds of laser beams are in many cases arranged separately, away from the main body of the exposure apparatus (exposure apparatus main body). Therefore, a transmitting optical system (a guiding optical system) having an optical system for optical axis adjustment called a beam matching unit is arranged in between the light source unit and the exposure apparatus main body, in order to match the optical axis position of the exposure light in between the exposure apparatus main body and the light source unit. In addition, when light from the light source unit enters the exposure apparatus main body with the optical axis greatly off the reference position of the exposure apparatus main body, exposure accuracy may be degraded due to uneven illuminance. Therefore, by adjusting the above beam matching unit, the optical axis mismatch between the light source unit and the exposure apparatus main body is corrected within a predetermined range.

However, the longer the distance of the transmitting optical system is from the light source unit to the exposure apparatus main body, only a slight shift in position or posture of the light source unit misaligns the optical axis of the light entering the exposure apparatus main body to a large extent. Therefore, for example, when the exposure apparatus main body and the light source unit are arranged on different floors, only a slight difference in the changes of floor surface properties with time creates a large shift in the above optical axis. In this case, when a shift occurred in the optical axis exceeding the correctable range of the beam matching unit, a great deal of workload was necessary for optical axis adjustment, such as, in moving the entire light source unit or changing its posture.

Especially, in recent years, with shorter oscillation wavelength, units such as capacitors having electric capacity corresponding to electric discharge capacity, blower fans for circulating operation media, and narrow bandwidth units for narrowing oscillation wavelengths are growing in size. This furthers the trend for a larger and heavier light source unit, and causes a great deal of workload for optical axis adjustment. Furthermore, when the light source unit is moved or posture control is performed for optical axis adjustment, in many cases mechanical connection between the transmitting optical system and the light source unit has to be redone, creating a troublesome task. In particular, when the exposure apparatus main body and the light source unit were arranged on different floors, or if there was an obstacle in between the units, the adjustment required a great deal of workload.

### SUMMARY OF THE INVENTION

The present invention was made under such circumstances, and has as its first object to provide an adjustment method of a light source unit that makes optical axis adjustment of light emitted from a light source unit possible without fail, with little workload.

The second object of the present invention is to provide an exposure method that can improve exposure accuracy.

The third object of the present invention is to provide a scanning exposure method that can prevent wasteful pulse consumption while maintaining the dose control precision.

The fourth object of the present invention is to provide a light source unit that can easily perform adjustment such as adjusting an optical axis of an outgoing light.

The fifth object of the present invention is to provide an exposure apparatus that can transfer a pattern of a mask onto a photosensitive object with high precision.

The sixth object of the present invention is to provide a scanning exposure apparatus that can prevent wasteful pulse consumption while maintaining the dose control precision.

And, the seventh object of the present invention is to provide a device manufacturing method that can produce microdevices with good productivity.

According to the first aspect of the present invention, there is provided an adjustment method of a light source unit that adjusts optical properties of light emitted from the light source unit via an outgoing opening, the light source unit including a housing in which the outgoing opening for the light is formed and a plurality of units housed in the housing, and the adjustment method including the process of adjusting an optical axis of the light by moving at least one unit of the plurality of units in the housing.

The outgoing opening, in this case, may be an opening formed in the housing, or it may be a type of window that has a plate-shaped member made up of a light transmitting member which blocks the opening, or a part of the housing may be formed of the light transmitting member. In short, an area of a predetermined size only has to be provided in a part of the housing, from where the light is emitted. In the description, the term “outgoing opening” is used in such a sense. In addition, the term “adjusts optical properties of light emitted from the light source unit via an outgoing opening” does not mean that the optical properties of the light that has been emitted via the outgoing opening are adjusted, but means that the optical properties of the light emitted via the outgoing openings are adjusted inside or outside the housing. That is, the term does not refer to adjusting the light emitted via the outgoing opening outside the outgoing opening (outside the housing).

With this method, since the optical axis adjustment is performed moving only at least one unit within the housing, the weight of the object to be moved is lighter, compared with the conventional art where the optical axis adjustment was performed moving the entire housing. In addition, since the optical axis adjustment is performed moving the units that structure the light source unit within the housing, the adjustment range can be broader, compared with when the light that has been emitted from the light source unit is adjusted using optical members in the optical system arranged outside the light source unit (adjustment of the optical axis position). Moreover, since the housing can be left untouched when performing optical axis adjustment, the connection between the housing and other units does not have to be reworked.

In this case, information related to positional relationship between the outgoing opening of the housing and the optical axis of the light can be measured when the optical axis is adjusted, and the optical axis can be adjusted based on results of the measurement. In such a case, the light passes though the outgoing opening of the housing without fail.

In this case, the adjustment method may further include: measuring information related to positional relationship between a reference position set in an optical system where the light emitted from the housing via the outgoing opening is incident and the optical axis of the light, and adjusting the optical axis based on results of the measurement.

With the adjustment method of the light source unit in the present invention, information related to positional relationship between a reference position set in an optical system where the light emitted from the housing via the outgoing opening is incident on and the optical axis of the light can be measured when the optical axis is adjusted, and the optical axis can be adjusted based on results of the measurement. In such a case, the optical axis of the light incident on the optical system can be adjusted on the light source unit side, with respect to the optical system. In addition, the adjustment mechanism on the optical system side can be simplified or omitted.

With the adjustment method of the light source unit in the present invention, the adjustment method can further include: adjusting at least one of wavelength, profile, and energy of the light after the optical axis is adjusted. In such a case, since either at least the wavelength, profile, or energy of the light is adjusted after the optical axis has been securely adjusted, the adjustment can be performed with more precision.

According to the second aspect of the present invention, there is provided an exposure method of illuminating a mask on which a pattern is formed with light from a light source unit that includes a housing in which an outgoing opening for the light is formed and a plurality of units are housed and transferring the pattern onto a photosensitive object, the exposure method including the process of: adjusting properties of the light emitted from the light source unit using an adjustment method of a light source unit in the present invention; and transferring the pattern onto the photosensitive object by illuminating the mask with the light which properties are adjusted.

With this exposure method, by using the adjustment method of the light source unit in the present invention, the properties of light illuminating the mask is adjusted with little workload without fail, and as a consequence, throughput and exposure accuracy can be improved.

According to the third aspect of the present invention, there is provided a first scanning exposure method of illuminating a predetermined illumination area on a mask with a pulse light from a pulse light source, moving synchronously the mask and a photosensitive object, and transferring a pattern formed on the mask onto the photosensitive object, wherein during scanning exposure, in a dose set range where scanning velocity of at least one of the mask and the photosensitive object can be maintained at a maximum scanning velocity, dose control is performed in a dose set range where the dose is set under a predetermined amount to maintain an exposure pulse number at a minimum exposure pulse number.

“Exposure pulse number”, in this case, means the number of pulses irradiated at one point on the photosensitive object during scanning exposure. In the description, the term “exposure pulse number” is used in such a sense.

With this scanning exposure method, on scanning exposure, dose control to maintain the exposure pulse number at a minimum exposure pulse number is performed in a dose set range where the dose is set under a predetermined amount, in a dose set range where scanning velocity of at least one of the mask and the photosensitive object can be maintained at a maximum scanning velocity. Therefore, in the present invention, by keeping the exposure pulse number constant which was hardly considered in the prior art, or to be more concrete, by the method of maintaining the minimum exposure pulse number, in a dose set range where the dose is set under a predetermined amount (a high sensitivity range) among dose set range where scanning velocity of at least one of the mask and the photosensitive object can be maintained at a maximum scanning velocity, exposure is performed at a minimum energy consumption regardless of the set dose. In addition, in this case, since exposure is performed at the minimum exposure pulse number in the above high sensitivity range, a desired dose control precision repeatability can be secured. Accordingly, wasteful pulse consumption is prevented and the cost can be reduced, while the dose control precision is maintained. In addition, since the energy consumption can be suppressed, a prolong effect on the life of the pulse light source and the optical system can be expected due to less workload.

In this case, the dose control can be performed by changing an energy density per pulse on a surface of the photosensitive object of the pulse light that is irradiated on the surface of the photosensitive object.

In this case, various methods can be used to change the energy density per pulse on the surface of the photosensitive object of the pulse light irradiated on the surface. For example, the change in the energy density per pulse can be performed by changing at least one of a pulse energy emitted from the pulse light source and an attenuation ratio of an attenuating unit that attenuates the pulse light.

With the first scanning exposure method in the present invention, when as the pulse light source, a laser light source which pulse energy is variable within a predetermined range is used, the pulse energy can be changed to maintain the exposure pulse number at a minimum exposure pulse number.

In this case, the pulse energy can be changed, by controlling a predetermined control factor related to oscillation of the laser light source. Incidentally, the control factor used to change the pulse energy may be either a single or a plurality of factors.

In this case, various types of laser light sources can be used as the laser light source. For example, a gas laser light source may be used as the laser light source, and in this case, the control factor can include factors such as the applied voltage (or charging voltage) in the laser light source or the gas state inside the laser tube. More particularly, as the laser light source, a pulse laser light source may be used that comprises a high voltage power supply and uses laser gas including rare gas and halogen gas. In this case, for example, the pulse energy can be changed, by controlling a power supply voltage in the high voltage power supply, as the control factor, or the pulse energy can be changed, by controlling a gas state of at least one of the rare gas and the halogen gas, as the control factor. In the latter case, the gas state subject to control can include gas pressure.

With the first scanning exposure method in the present invention, the exposure pulse number can be set to a minimum exposure pulse number, by changing an attenuation ratio of an attenuating unit arranged in between the pulse light source and the photosensitive object that attenuates the pulse light. In this case, the attenuation unit may be a unit that sets the attenuation ratio discretely, or a unit that set the attenuation ratio continuously.

With the first scanning exposure method in the present invention, during scanning exposure, in a dose set range where scanning velocity of at least one of the mask and the photosensitive object can be maintained at a maximum scanning velocity, dose control can be performed in a dose set range exceeding the predetermined amount in which the exposure pulse number exceeds the minimum exposure pulse number to maintain the maximum scanning velocity, by adjusting a repetition frequency of pulse emission of the pulse light source and the exposure pulse number. In such a case, similar to the above description, in a set range where the dose is under the predetermined value, the cost can be reduced by preventing wasteful pulse consumption, as well as the life of the pulse light source and optical system prolonged due to less workload on the units by suppressing energy consumption. In addition to this, in a set range where the repetition frequency of pulse emission necessary to obtain the maximum scanning velocity is within the maximum frequency, scanning exposure at the maximum scanning velocity is possible regardless of at least the set dose, and throughput can be maintained at a maximum.

According to the fourth aspect of the present invention, there is provided a second scanning exposure method of synchronously moving a mask and a photosensitive object with respect to a pulse light from a pulse light source and performing scanning exposure on the photosensitive object with the pulse light via the mask wherein during scanning exposure, in a dose set range where scanning velocity of at least one of the mask and the photosensitive object can be maintained at a maximum scanning velocity, dose control is performed in a dose set range where the dose is set under a predetermined amount to maintain an exposure pulse number at a minimum exposure pulse number, and in a dose set range where the dose is set exceeding the predetermined amount, dose control is performed to set the exposure pulse number more than the minimum exposure pulse number.

With this scanning exposure method, on scanning exposure, in the dose set range where scanning velocity of at least one of the mask and the photosensitive object can be maintained at the maximum scanning velocity, dose control is performed in the dose set range where the dose is set under a predetermined amount to maintain the exposure pulse number at the minimum exposure pulse number. Therefore, by keeping the exposure pulse number constant which was hardly considered in the prior art, or to be more concrete, by the method of maintaining the minimum exposure pulse number, in a dose set range where the dose is set under a predetermined amount (a high sensitivity range) among dose set range where scanning velocity of at least one of the mask and the photosensitive object can be maintained at a maximum scanning velocity, exposure is performed at a minimum energy consumption regardless of the set dose. In addition, in this case, since exposure is performed at the minimum exposure pulse number in the above high sensitivity range, a desired dose control precision repeatability can be secured. Also, in the dose set range where the dose is set exceeding the predetermined amount, since dose control is performed to set the exposure pulse number more than the minimum exposure pulse number, a desired dose control precision repeatability can be secured. Accordingly, wasteful pulse consumption is prevented and the cost can be reduced, while the dose control precision is maintained. In addition, since the energy consumption can be suppressed, a prolong effect on the life of the pulse light source and the optical system can be expected due to less workload.

In this case, neutral setting of the pulse light source can differ between scanning exposure and non-scanning exposure periods (that is, at least when one operation different from scanning exposure, such as the alignment operation of a mask (or a reticle) is performed), corresponding to stability properties of pulse emission in the pulse light source.

With the second scanning exposure method in the present invention, when pulse emission of the pulse light source pauses, based on values of pulse energy detected after the pulse emission restarts, a downtime learning table can be sequentially updated that stores a relationship between pulse energy emitted from the pulse light source and a predetermined control factor.

According to the fifth aspect of the present invention, there is provided a third scanning exposure method of illuminating a predetermined illumination area on a mask with a pulse light from a pulse light source, moving synchronously the mask and a photosensitive object, and transferring a pattern formed on the mask onto the photosensitive object, the exposure method including the steps of: detecting values of pulse energy of the pulse light source when pulse emission of the pulse light source restarts after a pause in the pulse emission of the pulse light source; and updating sequentially a downtime learning table by each set energy that stores a relationship between pulse energy emitted from the pulse light source and a predetermined control factor.

With this scanning exposure method, when the pulse emission from the pulse light source pauses, values of the pulse energy of the pulse light source is detected after the pulse emission restarts, and based on the detected values of the pulse energy, the downtime learning table by each set energy that stores the relationship between pulse energy emitted from the pulse light source and a predetermined control factor is sequentially updated. Therefore, even when the set energy is changed during the same downtime, optimum pulse energy control is possible without being affected by the change. The downtime learning table may also be created by each downtime.

According to the sixth aspect of the present invention, there is provided a light source unit, the unit comprising: a housing in which an outgoing opening where light is emitted is formed; a plurality of units housed in the housing; and a drive unit that moves at least one unit of the plurality of unit in the housing.

With this light source unit, the optical axis of light emitted from the housing can be adjusted with the drive unit moving at least one unit in the housing. Therefore, the weight of the object to be moved is lighter, compared with the conventional art where the optical axis adjustment was performed moving the entire housing. In addition, since the optical axis adjustment is performed moving the units that structure the light source unit within the housing, the adjustment range can be broader, compared with when the light that has been emitted from the light source unit is adjusted using optical members in the optical system arranged outside the light source unit (adjustment of the optical axis position). Moreover, since the housing can be left untouched when performing optical axis adjustment, the connection between the housing and other units does not have to be reworked.

In this case, the drive unit can move at least one unit of the plurality of unit in the housing, based on information related to a position of an optical axis of light emitted from the housing via the outgoing opening.

When the “information related to the position of the optical axis of light emitted from the housing via the outgoing opening” is obtained, for example, by photo-detecting the light, the photodetection position may either be inside or outside the housing. That is, the information related to the position of the optical axis of light emitted via the outgoing opening is not limited only to the information obtained outside the outgoing opening (or, outside the housing).

In this case, the unit can further comprise at least one of: a first measurement unit that measures information related to a positional relationship between the optical axis of the light and the outgoing opening of the housing, and a second measurement unit that measures information related to a positional relationship between a reference position set in an optical system on which the light emitted from the housing is incident and the optical axis of the light. When the light source unit comprises the first measurement unit, for example, at least one unit of a plurality of units are moved within the housing by the drive unit to adjust the position of the optical axis, based on the information related to the positional relationship between the outgoing opening of the housing and the optical axis of the light, measured by the first measurement unit. This operation makes the light pass through the outgoing opening without fail. In addition, when the light source unit comprises the second measurement unit, for example, the drive unit adjusts the position of the optical axis in a manner similar to the one described above, based on the information related to the positional relationship between the reference position set in the optical system on which the light emitted from the housing is incident and the optical axis of the light, measured by the second measurement unit. This operation adjusts the optical axis of light from the light source unit incident on the optical system. In this case, even when the optical system and the light source are arranged on different floors, or when an obstacle is arranged in between the two units, the optical axis adjustment can be performed with little workload.

With the light source unit in the present invention, the plurality of units can include an oscillation unit that oscillates the light, a measurement unit that measures at least one of wavelength, profile, and energy of the light, and a wavelength narrow bandwidth unit that narrows a wavelength bandwidth of light oscillated by the oscillation unit, and the drive unit can move at least two units of the oscillation unit, the measurement unit, and the wavelength narrow bandwidth unit together inside the housing.

According to the seventh aspect of the present invention, there is provided an exposure apparatus that transfers a pattern formed on a mask onto a photosensitive object, the exposure apparatus comprising: a light source unit of claim 26; an illumination optical system that guides light from the light source to the mask; and a projection optical system that projects light emitted from the mask onto the photosensitive object.

With this exposure apparatus, at least the position of the optical axis is securely adjusted with little workload, by the light source unit in the present invention. The light that has been adjusted is then guided to the mask by the illumination optical mask to illuminate the mask, the light emitted from the mask projected on the photosensitive object by the projection optical system, and the pattern transferred accurately onto the photosensitive object. In addition, even when the light source unit is detached from the illumination optical system, such as during the maintenance period, when the light source unit is reconnected to the illumination optical system after the maintenance, the positional adjustment of the optical axis of light incident on the illumination optical system from the light source unit can be swiftly performed with the drive unit. As a consequence, the downtime of the exposure apparatus can be reduced.

According to the eighth aspect of the present invention, there is provided a first scanning exposure apparatus that illuminates a predetermined illumination area on a mask with a pulse light from a pulse light source, moves synchronously the mask and a photosensitive object, and transfers a pattern formed on the mask onto the photosensitive object, the exposure apparatus comprising: a drive system that drives the mask and the photosensitive object synchronously in a predetermined scanning direction; and a control unit that controls synchronous movement of the mask and the photosensitive object via the drive system depending on a set dose and performs dose control during scanning exposure, the dose control performed in a dose set range where the dose is set under a predetermined amount to maintain an exposure pulse number at a minimum exposure pulse number, in a dose set range where scanning velocity of at least one of the mask and the photosensitive object is set at a maximum scanning velocity during the synchronous movement.

With this scanning exposure apparatus, during scanning exposure, the control unit controls the synchronous movement of the mask and the photosensitive object via the drive system, while in a dose set range where the scanning velocity of at least one of the mask and the photosensitive object is set at a maximum scanning velocity during the synchronous movement, performs dose control in the dose set range where the dose is set under a predetermined amount (the high sensitivity range) to maintain the exposure pulse number at the minimum exposure pulse number. Therefore, in the present invention, by keeping the exposure pulse number constant which was hardly considered in the prior art, or to be more concrete, by the method of maintaining the minimum exposure pulse number, in a dose set range where the dose is set under a predetermined amount (a high sensitivity range) among dose set range where scanning velocity of at least one of the mask and the photosensitive object can be maintained at a maximum scanning velocity, exposure is performed at a minimum energy consumption regardless of the set dose. In addition, in this case, since exposure is performed at the minimum exposure pulse number in the above high sensitivity range, a desired dose control precision repeatability can be secured. Accordingly, wasteful pulse consumption is prevented and the cost can be reduced, while the dose control precision is maintained. In addition, since the energy consumption can be suppressed, a prolong effect on the life of the pulse light source and the optical system can be expected due to less workload.

In this case, the control unit can change an energy density per pulse on a surface of the photosensitive object of the pulse light that is irradiated on the surface of the photosensitive object when performing the dose control.

In this case, when the exposure apparatus further comprises an attenuation unit that attenuates pulse light from the pulse light source, the control unit can change the energy density per pulse by changing at least one of a pulse energy emitted from the pulse light source and an attenuation ratio of an attenuating unit that attenuates the pulse light.

In this case, when the attenuation ratio of the attenuation unit can be discretely set, and when dose control is performed to maintain the exposure pulse number at the minimum exposure pulse number with attenuation using the attenuation unit, the control unit can adjust the pulse energy emitted from the pulse light source to maintain a repetition frequency of a pulse emission of the pulse light source during scanning exposure at a frequency corresponding to a minimum exposure pulse number under a condition of maximum scanning velocity.

With the first scanning exposure apparatus, on changing the energy density per pulse on a surface of the photosensitive object of the pulse light irradiated on the surface of the photosensitive object, if the pulse light source is a laser light source which pulse energy is variable within a predetermined range, the control unit can change the energy density per pulse by changing the pulse energy.

In this case, the control unit can change the pulse energy by controlling predetermined control factors related to oscillation of the laser light source. Incidentally, the control factor used to change the pulse energy may be either a single or a plurality of factors.

In this case, various types of laser light sources can be used as the laser light source. For example, a gas laser light source may be used as the laser light source, and in this case, the control factor can include factors such as the applied voltage (or charging voltage) in the laser light source or the gas state inside the laser tube. More particularly, as the laser light source, a pulse laser light source that comprises a high voltage power supply and uses laser gas including rare gas and halogen gas can be used.

In this case, for example, the control unit can control a power supply voltage in the high voltage power supply, as the control factor, or the control unit can control a gas state of at least one of the rare gas and the halogen gas, as the control factor. In the latter case, the gas state subject to control can include gas pressure.

With the first scanning exposure apparatus in the present invention, during scanning exposure, in a dose set range where scanning velocity of the mask and the photosensitive object can be maintained at a maximum scanning velocity, the control unit can perform dose control in a dose set range exceeding the predetermined amount in which the exposure pulse number exceeds the minimum exposure pulse number to maintain the maximum scanning velocity, by adjusting a repetition frequency of pulse emission of the pulse light source and the exposure pulse number.

With the first scanning exposure apparatus in the present invention, the control unit can make neutral setting of the pulse light source differ between scanning exposure and non-scanning exposure periods (that is, at least when one operation different from scanning exposure, such as the alignment operation of a mask (or a reticle) is performed), corresponding to stability properties of pulse emission in the pulse light source.

With the first scanning exposure apparatus in the present invention, the exposure apparatus can further comprise: a downtime learning table by each set energy that stores a relationship between pulse energy emitted from the pulse light source and a predetermined control factor and can be updated.

According to the ninth aspect of the present invention, there is provided a second scanning exposure apparatus that synchronously moves a mask and a photosensitive object with respect to a pulse light from a pulse light source, and performs scanning exposure on the photosensitive object with the pulse light via the mask, the exposure apparatus comprising: a drive system that drives the mask and the photosensitive object synchronously in a predetermined scanning direction; and a control unit that performs dose control during scanning exposure in a dose set range where scanning velocity of at least one of the mask and the photosensitive object can be maintained at a maximum scanning velocity, the dose control performed in a dose set range where the dose is set under a predetermined amount to maintain an exposure pulse number at a minimum exposure pulse number and in a dose set range where the dose is set exceeding the predetermined amount to set the exposure pulse number more than the minimum exposure pulse number.

With this scanning exposure apparatus, during scanning exposure, the control unit performs dose control in a dose set range where scanning velocity of at least one of the mask and the photosensitive object can be maintained at a maximum scanning velocity, and in the dose set range where the dose is set under a predetermined amount the dose control is performed to maintain an exposure pulse number at a minimum exposure pulse number. Therefore, by keeping the exposure pulse number constant which was hardly considered in the prior art, or to be more concrete, by the method of maintaining the minimum exposure pulse number, in a dose set range where the dose is set under a predetermined amount (a high sensitivity range) among dose set range where scanning velocity of at least one of the mask and the photosensitive object can be maintained at a maximum scanning velocity, exposure is performed at a minimum energy consumption regardless of the set dose. In addition, in this case, since exposure is performed at the minimum exposure pulse number in the above high sensitivity range, a desired dose control precision repeatability can be secured. Also, in the dose set range where the dose is set exceeding the predetermined amount, since the control unit performs dose control so that the exposure pulse number is set more than the minimum exposure pulse number, a desired dose control precision repeatability can be secured. Accordingly, wasteful pulse consumption is prevented and the cost can be reduced, while the dose control precision is maintained. In addition, since the energy consumption can be suppressed, a prolong effect on the life of the pulse light source and the optical system can be expected due to less workload.

According to the tenth aspect of the present invention, there is provided a third scanning exposure apparatus that illuminates a predetermined illumination area on a mask with a pulse light from a pulse light source, moves synchronously the mask and a photosensitive object, and transfers a pattern formed on the mask onto the photosensitive object, the exposure apparatus comprising: a downtime learning table by each set energy that stores a relationship between pulse energy emitted from the pulse light source and a predetermined control factor and can be updated.

With this scanning exposure apparatus, even when set energy is changed during the same downtime, an optimum pulse energy control is possible without being affected by such changes. The downtime learning table may also be created by each downtime.

In addition, in a lithographic process, by using the exposure method in the present invention, since the throughput and exposure accuracy are improved, it is possible to improve the production capacity and the accuracy of the pattern formed. In addition, by using any one of the first to third scanning exposure methods in the present invention, the pattern formed on the mask can be accurately transferred onto the photosensitive object, and when the pattern is transferred wasteful pulse consumption can be prevented, which leads to a cost reduction, and also suppress energy consumption. Accordingly, in any case, high integration microdevices can be produced with high precision, while reducing the cost. In addition, in a lithographic process, by using any of the first to third scanning exposure apparatus in the present invention to perform exposure, high integration microdevices can be produced with high precision, while reducing the cost. Especially when the second scanning exposure apparatus is used for exposure, a dose control with higher precision is possible, and the pattern can be formed accurately on the photosensitive object.

Accordingly, in the present invention, furthermore from another aspect, there is provided a device manufacturing method using the exposure method of the present invention and any one of the first to third scanning exposure methods in the present invention, or a device manufacturing method using any one of the first to third exposure apparatus in the present invention.

### BRIEF DESCRIPTION OF THE DRAWINGS

In the accompanying drawings;

FIG. 1 is a view showing an entire configuration of an exposure apparatus related to an embodiment in the present invention;

FIG. 2 is a view showing a configuration of a light source unit in FIG. 1;

FIG. 3 is a planar view of a posture control unit viewed along a line A-A in FIG. 2;

FIG. 4 is a block diagram showing a model related to posture control of units inside a housing by a posture control unit;

FIGS. 5A to 5D respectively show examples of structures in a photodetector serving as a measurement unit;

FIG. 6 is a view showing an exposure apparatus in FIG. 1 omitting a part of its arrangement such as a main body column;

FIG. 7 is a flow chart showing the dose control algorithm of a CPU in a main controller;

FIG. 8 is a flow chart for explaining an embodiment of a device manufacturing method according to the present invention; and

FIG. 9 is a flow chart for showing a process in step 204 in FIG. 8.

### DETAILED DESCRIPTION OF THE PREFERRED EMBODIMENTS

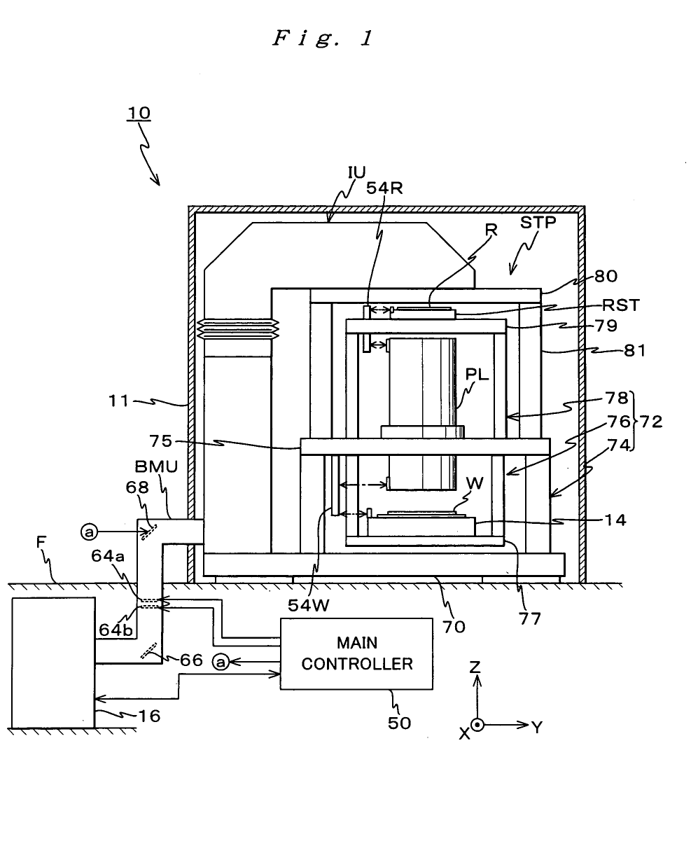

Following is a description of an embodiment related to the present invention, referring to FIGS. 1 to 7.

FIG. 1 shows an entire configuration of an exposure apparatus 10 related to the embodiment that comprises a light source unit of the present invention serving as the light source for exposure. Exposure apparatus 10 is a scanning exposure apparatus based on a step-and-scan method, that is, a so-called scanning stepper.

Exposure apparatus 10 comprises: an exposure apparatus main body STP arranged on a floor surface F inside a clean room in a semiconductor manufacturing factory; a chamber 11 which houses the exposure apparatus main body; a light source unit 16 arranged in a utility space provided beneath floor surface F; and a transmitting optical system that optically connects light source unit 16 and exposure apparatus main body STP, the system partially having an optical system for optical axis adjustment called a beam matching unit. In the description hereinafter, the transmitting optical system will be referred to simply as the beam matching unit BMU, unless further description is necessary. Light source unit 16 may be set not only in the above utility space, but also on the same floor surface at a position away from where exposure apparatus main body STP is arranged, or in a service room which is a room different from the clean room where the exposure apparatus main body is arranged.

Exposure apparatus main body STP comprises: a base plate 70 arranged on the floor surface of chamber 11; a main body column 72 mounted on base plate 70; a projection optical system PL mounted on main body column 70; a reticle stage RST that holds a reticle R serving as a mask, an XY stage 14 that holds a wafer W serving as a photosensitive object, and the like; an illumination unit IU; and the like.

Main column 72 is arranged on base plate 70, comprising: a first column 74 that holds projection optical system PL; a second column 76 that is supported by suspension by the fist column 74 and supports XY stage 14; and a third column 78 that is mounted on the first column 74 and supports reticle stage RST.

Following is a description of each portion structuring main column 72 in detail. The first column 74 is made up of a barrel supporting bed 75 that holds projection optical system PL and a plurality of leg portions supporting barrel supporting bed 75, such as three leg portions. On a part of each leg portion, a vibration isolation unit may be provided. In addition, the second column 76 is made up of a wafer stage supporting bed 77 on which a movement guide surface for XY stage 14 is formed, and a plurality of support members that support wafer stage supporting bed 77 by suspension with respect to barrel supporting bed 75, such as three support members. Also, the third column 78 is made up of a reticle stage supporting bed 79 on which a movement guide surface for reticle stage RST is formed and a plurality of legs supporting reticle stage supporting bed 79, such as three legs. In the part of reticle stage supporting bed 79 above projection optical system PL, an aperture (not shown) is formed which serves as a path for the exposure light.

In addition, on the upper surface of barrel supporting bed 75, a plurality of pillars 81, such as three extending in the vertical direction are fixed on the outer side of the third column 78. And, on top of the upper end of these pillars 81, a support member 80 is fixed to support a part of illumination unit IU. In the part of support member 80 above projection optical system PL, an aperture (not shown) is formed which serves as a path for the exposure light.

The structure of exposure apparatus main body STP will be described, later in the description.

To the inside of chamber 11, gas (such as air) which level of cleanliness, temperature, and the like are controlled tighter than that of the clean room outside, is supplied from an air conditioning unit (not shown).

As light source unit 16, as an example, a KrF excimer laser light source (oscillation wavelength: 248 nm) which pulse energy per pulse E is variable within the range of Eₘᵢₙ (such as 8 mJ/pulse) to Eₘₐₓ (such as 10 mJ/pulse) and also repetition frequency f of the pulse emission is variable within the range of fₘᵢₙ (such as 600 Hz) to fₘₐₓ (such as 2000 Hz) is used. Therefore, in the following description, light source unit 16 will be referred to as “excimer laser light source 16” as appropriate.

Incidentally, instead of the excimer laser light source 16, as long as it has the function of changing the pulse energy and the repetition frequency like the above description, an Arf excimer laser light source (oscillation wavelength: 193 nm), an F₂ laser light source (oscillation wavelength: 157 nm), or even a metal vapor laser light source or a harmonic generator of a YAG laser can be used as a pulse light source.

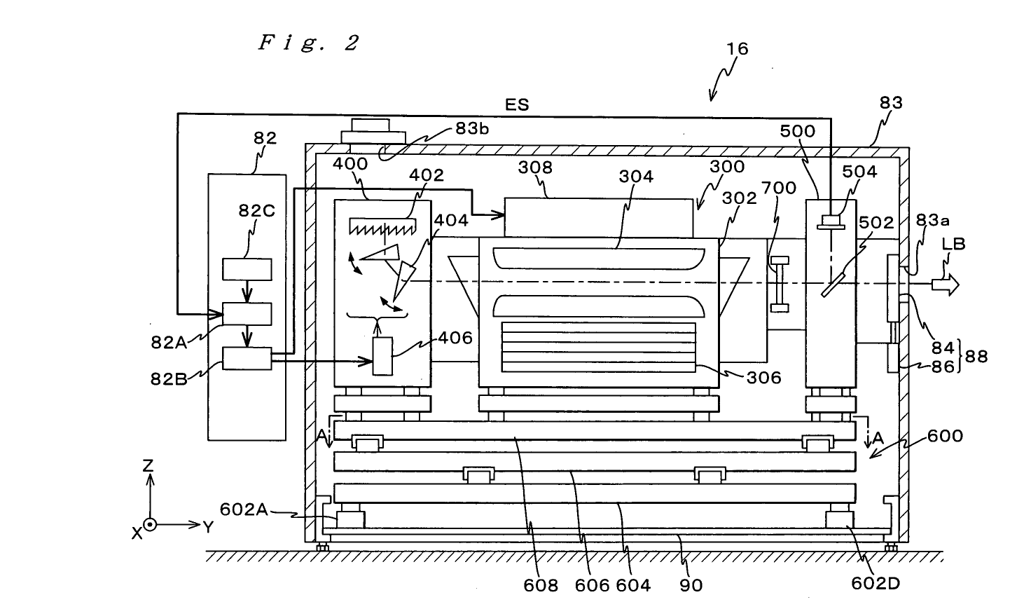

FIG. 2 shows an internal structure of light source unit 16 along with a control unit 82. As is shown in FIG. 2, light source unit 16 comprises: a housing 83; and in housing 83 a laser oscillation unit 300, a wavelength narrow bandwidth unit 400, a measurement unit 500 are housed with an X-axis table on which the three units 300, 400, and 500 are mounted, as well as a posture control unit 600 serving as a drive unit that controls the position and posture of each unit, and the like.

Laser oscillation unit 300 has a laser chamber (an excimer laser tube) 302, which is filled with laser gas of a predetermined concentration (made up of Krypton Kr and Fluorine F₂ serving as a medium, and Helium serving as a buffer gas). To laser chamber 302, an exhaust piping made up of a flexible tube or the like is connected via an exhaust valve (not shown). In addition, to laser chamber 302, one end of a flexible gas supply piping is connected via a gas supply valve (not shown), and the other ends of the gas supply piping are connected to gas cylinders (not shown) that contain gases such as Kr, F₂, and He.

Each of the above valves operates under the control of main controller 50 (refer to FIG. 1). For example, main controller 50 adjusts the concentration ratio and pressure of the laser gas within laser chamber 302 so that it keeps a predetermined level during operations such as gas exchange.

Within laser chamber 302, parts such as a discharging electrode 304 and a blower fan 306 for gas circulation are housed. In addition, on top of laser chamber 302, a laser power supply (high voltage power supply) 308 is mounted.

Wavelength narrow bandwidth unit 400 is arranged on the −Y side of laser oscillation unit 300, that is, on the side opposite to the outgoing side of the laser beam. As is shown in FIG. 2, inside wavelength narrow bandwidth unit 400, it comprises: a reflection type diffraction grating (grating) 402 with variable tilt that also serves as a rear mirror; a prism 404 with a variable tilt; and a drive portion 406 that drives reflection type diffraction grating (grating) 402 and prism 404.

On the +Y side of laser oscillation unit 300, that is, on the outgoing side of the laser beam a half mirror (a low reflectance mirror) 700 serving as a front mirror is arranged. In the embodiment, a resonator is formed for laser oscillation by reflection type diffraction grating 402 and half mirror 700, in order to increase coherency. In addition, reflection type diffraction grating 402 and prism 404 form a narrow bandwidth module. The narrow bandwidth module narrows the spectral width of laser beam LB emitted from laser chamber 302 into around 1/100 to 1/300 of the natural oscillation spectral width. In this case, reflection type diffraction grating 402 is for rough adjustment, and prism 404 is for fine adjustment. In addition, by adjusting the tilt of prism 404, the wavelength (center wavelength) of laser beam LB emitted from laser chamber 302 can be shifted within a predetermined range.

Incidentally, configuration of the narrow bandwidth module and the resonator above is a mere example, and the configuration can include a fixed Fabry-Perot etalon and a Fabry-Perot etalon with a variable tilt (hereinafter referred to as “etalon” for short) that are sequentially arranged in between laser chamber 302 and half mirror 700. In this case, a total reflection mirror can makeup the rear mirror structuring the resonator with half mirror 700. And, in this case, the fixed etalon is for rough adjustment, and the etalon with variable tilt is for fine adjustment. In addition, by adjusting the tilt of the etalon with variable tilt, the wavelength of laser beam LB emitted from laser chamber 302 can be shifted within a predetermined range.

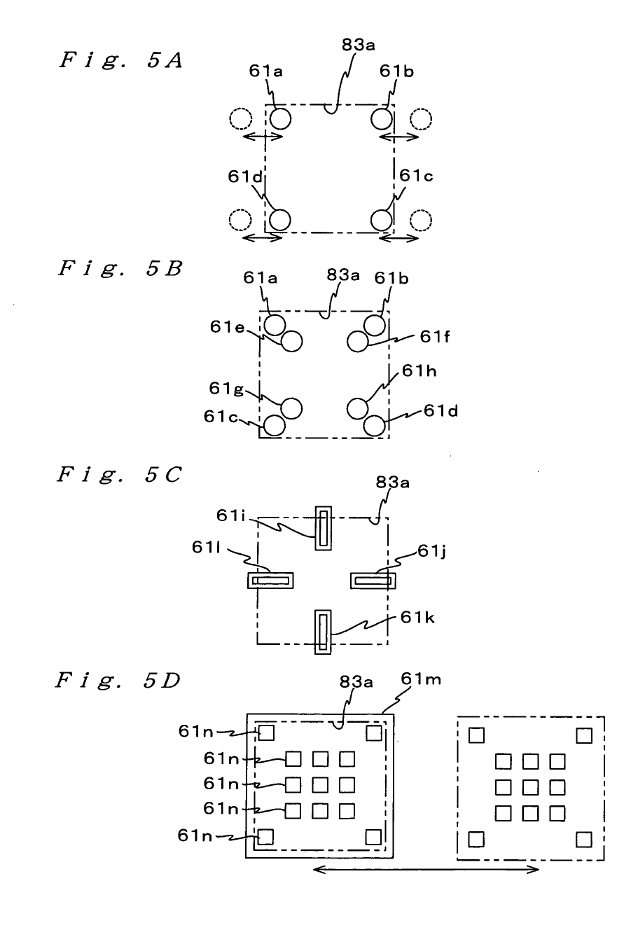

Measurement unit 500 is arranged on the +Y side of half mirror 700, and it measures at least one of wavelength, profile, and energy of laser beam LB (pulse ultraviolet light). As is shown in FIG. 5, measurement unit 500 comprises: abeam splitter 502 arranged on the +Y side of half mirror 700 having high transmittance and low reflectance; and a beam monitor 504 arranged on an optical path of light reflected off beam splitter 502 that monitors the wavelength of the reflected light by beam splitter 502. Beam monitor 504 comprises: a half mirror; a condenser lens; a collimator lens; an etalon; and a telemeter lens that are sequentially arranged on the optical path of the reflected beam; a line sensor; an energy monitor made up of, for example, a PIN type photodiode, arranged on an optical path of light reflected off the half mirror (all of which are not shown), and the like. Of these parts, the condenser lens, the collimator lens, the etalon, the telemeter lens, and the line sensor make up a Fabry- Perot interferometer which measures the wavelength, profile, and the like of laser beam LB (pulse ultraviolet light). In addition, the energy monitor measures the energy (the pulse energy) of laser beam LB.

Control unit 82 comprises: an adjustment amount calculation portion 82A; and a drive control portion 82B. Adjustment amount calculation portion 82A calculates the adjustment amount in the tilt (angle) of prism 404 and reflection type diffraction grating 402 that structure wavelength narrow bandwidth unit 400, based on the output wavelength (oscillation center wavelength) of laser beam LB (pulse ultraviolet light) measured by beam monitor 504. And, based on the information from adjustment amount calculation portion 82A, drive control portion 82B sets the tilt (angle) of prism 404 and reflection type diffraction grating 402 at a suitable angle via drive portion 406. In addition, in control unit 82, an input portion 82C such as a console is provided, and input information such as wavelength that should be set can be input via input portion 82C. Adjustment amount calculation portion 82A calculates the wavelength adjustment amount related to the narrow bandwidth module (prism 404 and reflection type diffraction grating 402), based on measurement information from beam monitor 504 and input information from input portion 82C. Other than the oscillation center wavelength of the laser beam referred to above, control unit 82 also controls the spectral radiation bandwidth of the emitted pulse ultraviolet beam, the trigger timing of the pulse oscillation, gases in chamber 14, and the like.

In the embodiment, main controller 50 changes the output of excimer laser light source 16 (the pulse energy of laser beam LB) by controlling control factors (or control parameters) related to oscillation of excimer laser light source 16. The control factors used to change the pulse energy may be only one or more, however, in the embodiment, applied voltage (or charging voltage) of excimer laser light source 16 and the state of gas within laser chamber 302 are each independently controlled as a control factor, and the state of gas is to include gas pressure of at least one laser gas (such as Kr, F₂, and He). The above control unit 82 controls the control factors of excimer laser light source 16, and based on a target value of pulse energy per pulse sent from main controller 50 it controls at least one of the above two control factors so that the pulse energy of laser beam LB emitted from excimer laser light source 16 nearly coincides with the target value. When the state of gas is controlled as the control factor, control unit 82 controls the gas pressure of gas such as rare gas (Kr) and halogen (F₂) according to the output of a sensor (not shown) that detects the pressure of the laser gas. In addition, inside laser chamber 302, blower fan 306 circulates the laser gas at all times.

In housing 83, on a side wall on the +Y side an opening 83a is formed, serving as an outgoing opening. In addition, in housing 83, a shutter portion 88 is provided that opens/closes opening 83a. Shutter portion 88 is formed, including a movable blade 84, and an actuator 86 such as a cylinder to drive movable blade 84.

In housing 83, on a ceiling wall an exhaust opening 83b is provided, which is connected to an exhaust unit (not shown).

With a laser generating portion having the above structure (each of the parts structuring light source unit 83 excluding posture control unit 600), laser beam LB emitted in pulses from laser chamber 302 enters beam splitter 502 that has high transmittance and low reflectance, and laser beam LB having passed through beam splitter 16b is emitted outside via opening 83a. Meanwhile, laser beam LB reflected off beam splitter 502 enters the energy monitor (and the Fabry-Perot interferometer) within beam monitor 504. And, photoelectric conversion signals from the energy monitor are sent as output ES via a peak hold circuit (not shown) to adjustment amount calculation portion 82A within control unit 82, and to drive control portion 82B via adjustment amount calculation portion 82A. The unit for energy control amount corresponding to output ES of energy monitor is (mJ/pulse). During normal emission, control unit 82 (to be more precise, drive control portion 82B) performs feedback control on power supply voltage (corresponding to the applied voltage or the charging voltage described earlier) in laser power supply 308, so that output ES of the energy monitor is a value corresponding to a target value of energy per pulse, which is among control information TS sent from main controller 50. In addition, control unit 82 (to be more precise, drive control portion 82B) also changes the oscillation frequency by controlling the energy supplied to laser oscillation unit 300 via laser power supply 308. That is, control unit 82 sets the oscillation frequency of excimer laser light source 16 to a frequency instructed by main controller 50, according to control information TS sent from main controller 50, as well as performs feedback control on power supply voltage in laser power supply 308, so that the energy per pulse in excimer laser light source 16 reaches the value instructed by main controller 50.

Incidentally, control unit 83 opens and closes movable blade 84 via actuator 86 for example, either based on instructions from main controller 50, or on its own decision.

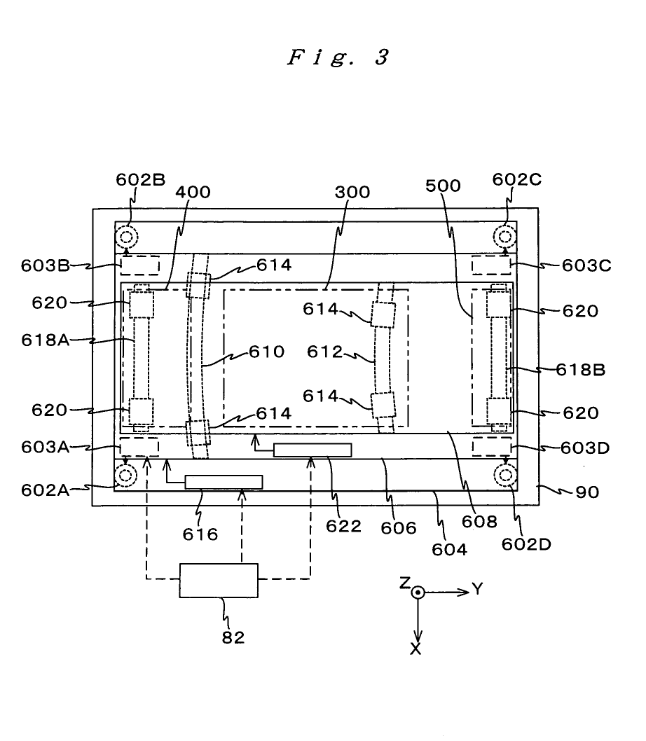

Next, a structure of posture control unit 600 will be described, based on FIG. 2 and FIG. 3, which shows an entire planar view of a posture control unit 600, along line A-A in FIG. 2.

As is shown in FIG. 2, posture control unit 600 comprises: elevating mechanisms 602A, 602B, 602C, and 602D (elevating mechanisms 602B and 602C, arranged in the depth of the page surface, are not shown in FIG. 2 (refer to FIG. 3)) that are each arranged on the four corners of a platform 90 that structure a bottom wall of housing 83 and are capable of freely elevating in the Z-axis direction; a Z-axis table 604 supported by elevating mechanisms 602A to 602D; a rotary table 606 arranged on Z-axis table 604; and an X-axis table 608 arranged on rotary table 606. On X-axis table 608, laser oscillation unit 300, wavelength narrow bandwidth unit 400, and measurement unit 500, which were described earlier, are mounted via vibration isolation portions that suppress or remove vibration, respectively.

Elevating mechanisms 602A to 602D are each made up of, for example, a combination of ball screws and gears, and are each elevated via actuators 603A to 603D (refer to FIG. 3) such as motors. Actuators 603A to 603D are controlled individually by control unit 82, described earlier, which drives each of elevating mechanisms 602A to 602D so as to elevate the four corners of Z-axis table 604 in the Z-axis direction (vertical direction). In this case, when the elevating amount of the elevating mechanism in the Z-axis direction is the same, then Z-axis table 604 moves in parallel in the Z-axis direction. Also, when the elevating amount of the elevating mechanism in the four corners are different and do not cause interference with one another, Z-axis table 604 can be driven in any tilt direction, that is, in the θx direction which is the rotational direction around the X-axis and the θy direction which is the rotational direction around the Y-axis.

As is shown in FIG. 3, on Z-axis table 604, a pair of large and small arcuated guide rails 610 and 612 having a predetermined point as a center is arranged, and a plurality of sliders 614 that can slide freely along guide rails 610 and 612 are fixed on rotary table 606. To rotary table 606, an actuator 616 such as a motor is connected, and by controlling actuator 616, control unit 82 can rotate rotary table 606 in the θz direction (the rotational direction around the Z-axis) with the Z-axis passing through the predetermined point referred to above serving as the center.

On rotary table 606, a pair of guide rails 618A and 618B is arranged on both ends in the Y-axis direction, that is, on one end and the other end, extending in the X-axis direction. A plurality of sliders 620 that can slide freely along guide rails 618A and 618B are fixed to X-table 608. To X-table 608 an actuator 622 such as a motor is connected, and by controlling actuator 622, control unit 82 can drive X-table 608 in the X-axis direction.

That is, in the embodiment, since posture control unit 600 is structured as in the above description, X-axis table 608 can be driven freely in the directions of five degrees of freedom excluding the Y-axis (X, Z, θx, θy, and θz directions), which allows laser oscillation unit 300, wavelength narrow bandwidth unit 400, and measurement unit 500 to change in position and posture freely in the above directions of five degrees of freedom altogether.

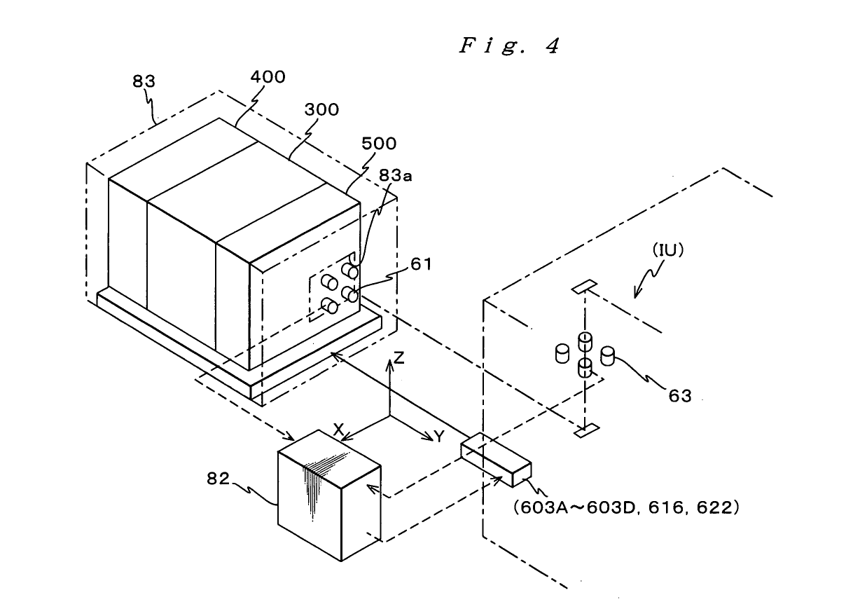

FIG. 4 shows a model of a block diagram related to posture control of units 300, 400, and 500 inside housing 83 by posture control unit 600. As is shown in FIG. 4, in the embodiment, in the vicinity of opening 83a of housing 83, a first photodetector 61 is arranged, which serves as a first measurement unit that measures information related to a position of an optical axis of laser beam (pulse ultraviolet light) LB, or to be more concrete, the positional relationship of opening 83a of housing 83 and the optical axis of laser beam LB. In addition, on an optical path of an illumination optical system (to be described later) inside illumination unit IU where laser beam (pulse ultraviolet light) LB emitted from light source unit 16 is incident, a second photodetector 63 is arranged, which serves as a second measurement unit that measures information related to a position of an optical axis of laser beam LB, or to be more concrete, the positional relationship of a reference position set in the illumination optical system and the optical axis of laser beam LB. The measurement results of photodetectors 61 and 63 are sent to control unit 82, and the above actuators 603A to 603D, 616, and 622 are driven under the control of control unit 82. Incidentally, the arrangement position of the first photodetector 61 only has to be close to opening 83a of housing 83, and may either be arranged inside or outside housing 83.

FIGS. 5A to 5D show examples of arrangements of the above photodetectors 61 and 63 of the first photodetector 61 and the second photodetector 63, the first photodetector 61 arranged in the vicinity of opening 83a of housing 83 will be representatively described in the following description. The second photodetector 63, which is arranged on the optical path of the above illumination optical system, can also be structured similar to the first photodetector 61.

In FIG. 5A, four photodetectors 61a to 61d made up of photodiodes, pyroelectric elements, photoconductive elements, and the like are arranged in the four corners of opening 83a of housing 83. In this case, photodetectors 61a to 61d are structured so that they can each move freely in between a position off opening 83a and the above four corners. And, with control unit 82 analyzing the detection signals of laser beam LB from photodetectors 61a to 61d, the skirts of the intensity profile of laser beam LB can be detected. Based on the detection results (for example, by comparing the detection results of photodetectors 61a to 61d) information on positional relationship between opening 83a and the optical axis of laser beam LB within an XZ plane, such as positional shift amount of the optical axis of laser beam LB with respect to the center of opening 83a, can be obtained.

In addition, as in FIG. 5B, eight photodetectors 61a to 61h made up of photodiodes, pyroelectric elements, photoconductive elements, and the like are arranged in the vicinity of the four corners of opening 83a of housing 83, two in each corner as a pair. When photodetectors 61a to 61h are arranged in this manner, not only can they detect the skirts of the intensity profile of laser beam LB but can also detect the tilt in the intensity of the skirts. This allows the positional shift of laser beam LB with respect to the center of opening 83a to be detected with more accuracy.

In addition, as in FIG. 5C, four linear optical sensors 61i to 61l are arranged, respectively, in the midpoint of the four sides of opening 83a. By arranging linear optical sensors 61i to 61l in this manner, the skirts of the intensity profile of laser beam LB can be detected, as well as the intensity distribution along the longitudinal direction of linear optical sensors 61i to 61l. This allows the positional shift of laser beam LB with respect to the center of opening 83a to be detected with more accuracy.

In addition, as in FIG. 5D, a plate-shaped fixed unit 61m is arranged so that it can slide freely within an XZ plane, which is almost perpendicular to the optical axis of laser beam LB. And, on plate-shaped fixed unit 61m, a plurality of photodetectors (in this case, 13) 61n made up of photodiodes, pyroelectric elements, photoconductive elements, and the like are fixed. In this case, since the plurality of photodetectors 61n are arranged on plate-shaped fixed unit 61m two dimensionally, photodetectors 61n can directly detect the intensity profile (sectional light intensity distribution) itself of laser beam LB. Accordingly, not only can the positional shift of the optical axis of laser beam LB be obtained but also the angular shift can be obtained.

Control unit 82, which is previously referred to, can adjust the optical axis of laser beam LB by controlling each of the actuators structuring posture control unit 600 based on the detection results of at least either the first photodetector 61 or the second photodetector 63, and controlling the position and posture of units 300, 400, and 500 inside housing 83. When the detection results of the first photodetector 61 is used, the position of the optical axis of laser beam LB can be adjusted with respect to the center of opening 83a of housing 83, whereas when the detection results of the second photodetector 63 is used, the position of the optical axis of laser beam LB can be adjusted with respect to the reference position set in the illumination optical system where laser beam LB enters.

Referring back to FIG. 1, with beam matching unit BMU, one end (the entering end) is connected to light source unit 16, and the other end (the outgoing end) is connected to the housing of illumination unit IU which makes up exposure apparatus main body STP, via an opening formed in chamber 11. In this case, beam matching unit BMU and illumination unit IU, and also beam matching unit BMU and light source unit 16 are connected, for example with a light shielding bellows and pipes. Beam matching unit BMU is supported fixed to the floor and struts or the like of the chamber via fasteners (not shown). In addition, beam matching unit BMU may be connected to illumination unit IU via the floor surface, instead of the side surface of the chamber.

Inside beam matching unit BMU, a deflection mirror 66, parallel plate glasses 64a and 64b, a movable mirror 68, a zoom lens (or a beam expander), a relay optical system (all of which are not shown) and the like are arranged in a predetermined positional relationship. As in FIG. 1, laser beam LB emitted from light source unit 16 enters parallel plate glasses 64a and 64b, after it is deflected by deflection mirror 66 arranged inside beam matching unit BMU. After the sectional shape of laser beam LB emitted from parallel plate glasses 64a and 64b is formed into a predetermined shape via the zoom lens (not shown), laser beam LB enters illumination unit IU via movable mirror 68 and the relay optical system (not shown). Parallel plate glasses 64a and 64b are each rotated with a rotary motor (not shown), and movable mirror 68 is driven so it can slide by an actuator made up of, for example, a moving coil type linear motor. These rotary motor and actuator operate under the control of main controller 50.

Details on the beam matching unit are disclosed in, for example, Japanese Laid-open No. 10-229044 and the corresponding U.S. Pat. No. 5,963,306. The above U.S. Patent disclosure is fully incorporated herein by reference.

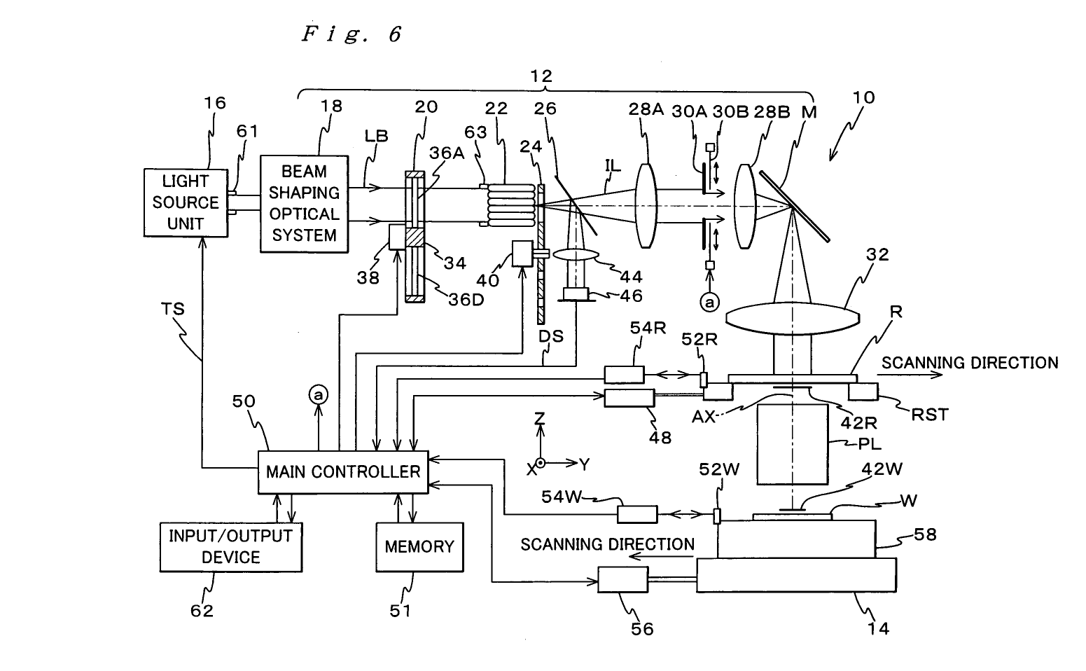

Next, each portion that structure exposure apparatus main body STP will further be described in detail, referring to FIG. 6. FIG. 6 shows exposure apparatus 10 with a part of its structure such as the main body column omitted.

Inside the housing of illumination unit IU, an illumination optical system 12 is housed, as is shown in FIG. 6. Illumination optical system 12 comprises: a beam shaping optical system 18; a rough energy adjuster 20 serving as an attenuation device; an optical integrator (such as a fly-eye lens, an internal reflection type integrator, or a diffraction optical element; since a fly-eye lens is used in FIG. 6, it will hereinafter also be referred to as “fly-eye lens”) 22; an illumination system aperture stop 24; a beam splitter 26; a first relay lens 28A; a second relay lens 28B; a reticle blind serving as a field stop (in the embodiment, the reticle blind is made up of a fixed reticle blind 30A and a movable retile blind 30B); a mirror M which deflects an optical path; a condenser lens 32; and the like.

Beam shaping unit 18 is a unit that shapes the sectional shape of laser beam LB emitted from excimer laser light source 16 so that it efficiently enters fly-eye lens 22 arranged down the optical path of laser beam LB, and is made up of parts such as a cylinder lens or a beam expander (none of which are shown).

Rough energy adjuster 20 is arranged on the optical path of laser beam LB, downstream of beam shaping unit 18. With rough energy adjuster 20, a plurality of (six, for example) ND filters (only two ND filters, 36A and 36D, are shown in FIG. 1) which transmittance (=1—attenuation ratio) differ, are arranged in the periphery of a carousel 34. And by rotating carousel 34 by a drive motor 38, transmittance with respect to the incident laser beam LB can be switched from 100%, geometrically, in a plurality of steps. Drive motor 38 is under the control of main controller 50. Another carousel similar to carousel 34 may be also arranged, and the transmittance may be adjusted more precisely by combining the two sets of ND filters.

Fly-eye lens 22 is arranged on the optical path of laser beam LB, downstream of the rough energy adjuster 20. Fly-eye lens 22 forms a surface light source made up of a large number of point light sources, that is, a secondary light source on the focal plane on the outgoing side, in order to illuminate reticle R with uniform illuminance distribution. The laser beam emitted from this secondary light source is hereinafter referred to as “pulse illumination light IL”.

On the incident surface side of fly-eye lens 22 (for example, in between beam shaping optical system 18 and rough energy adjuster 20), the second photodetector 63, described earlier, is arranged. In addition, in the vicinity of the outgoing surface of fly-eye lens 22, that is, on the focal plane on the outgoing side which almost coincides with the pupil plane of the illumination optical system in this embodiment, illumination system aperture stop 24 made up of a discoid member is arranged. In illumination system aperture stop 24, aperture stops of different types such as, an aperture stop made up of a normal circular aperture, an aperture stop made up of small circular apertures to lower a value a which is a coherence factor, a ring-shaped aperture stop for annular illumination, and a modified apertures top made up of a plurality of apertures arranged in an eccentric manner for modified illumination, or the like, are arranged at an equiangular interval (only two types of these apertures are shown in FIG. 6). Illumination system aperture stop 24 is rotated by a drive unit 40 such as a motor controlled by main controller 50, allowing one of the aperture stops to be selectively chosen to be set on the optical path of the pulse illumination light IL. Instead of illumination system aperture stop 24, or combined with illumination system aperture stop 24, for example, by arranging an optical unit including at least either a plurality of diffraction optical elements arranged alternately within the illumination optical system, a prism (such as a conic prism or a polyhedron prism) movable along the optical axis of the illumination optical system, or a zoom optical system in between light source unit 16 (to be more specific, in between rough energy adjuster 20) and optical integrator 22, and by making the intensity distribution of the illumination light on the incident surface variable when optical integrator 22 is a fly-eye lens or by making the incident angle range of the illumination light with respect to the incident surface or the like variable when optical integrator 22 is a internal reflection type integrator, it is preferable to suppress the dose distribution (the size and shape of the secondary light source) of the illumination light on the pupil plane of the illumination optical system, that is, to suppress the dose loss that occur when the illumination conditions are changed.

On the optical path of pulse illumination light IL, downstream of the illumination system aperture stop 24, beam splitter 26 is arranged, having low reflectance and high transmittance. Further down the optical path, a relay optical system made up of first relay lens 28A and second relay lens 28B is arranged, with fixed reticle blind 30A and movable reticle blind 30B arranged in between the relay lenses.

Fixed reticle blind 30A is arranged on a plane slightly defocused from a conjugate plane with respect to a pattern surface of reticle R, and has a rectangular aperture formed so as to set an illumination area 42R on reticle R. In addition, in the vicinity of fixed reticle blind 30A, movable reticle blind 30B is arranged that has an aperture portion which position and width are variable in a direction corresponding to the scanning direction, so as to further limit illumination area 42R at the beginning and end of scanning exposure in order to prevent exposing unnecessary portions. Furthermore, the width of aperture in movable reticle blind 30B can also be changed in a direction corresponding to the non-scanning direction, which is a direction perpendicular to the scanning direction, so that the width of illumination area 42R can be adjusted in the non-scanning direction in accordance with the pattern of reticle R to be transferred onto the wafer. In the embodiment, by slightly defocusing fixed reticle blind 30A, intensity distribution of illumination light IL on reticle R in the scanning direction is a near trapezoidal shape, however, other arrangements may be employed to form a trapezoidal intensity distribution of illumination light IL, such as, arranging a concentration filter that gradually increases the attenuation ratio in the periphery portion or a diffraction optical element that partially diffracts the illumination light inside the illumination optical system. In addition, in the embodiment, both fixed reticle blind 30A and movable reticle blind 30B are arranged, however, only the movable retile blind may be arranged without arranging the fixed reticle blind.

On the optical path of pulse illumination light IL, downstream of the second relay lens 28B structuring the relay optical system, a mirror M is arranged which reflects pulse illumination light IL that has passed through the second relay lens 28B toward reticle R. Further down the mirror M on the optical path of pulse illumination light IL, condenser lens 32 is arranged.

Meanwhile, pulse illumination light IL, which is reflected off beam splitter 26, is received by an integrator sensor 46 made up of a photoconversion element via a condenser lens 44. Photoelectric conversion signals of integrator sensor 46 are sent to main controller 50 as an output DS (digit/pulse) via a peak hold circuit and an A/D converter (not shown). As integrator sensor 46, a PIN type photodiode or the like that is sensitive in the far ultraviolet region and has high response frequency for detecting the pulse emission of excimer laser light source 16 can be used. A relative coefficient of output DS of integrator sensor 46 and the illuminance (dose) of pulse illumination light IL on the surface of the wafer W is obtained in advance, and is stored in a memory 51 serving as a storage unit arranged with main controller 50.

On reticle stage RST, reticle R is held by suction via vacuum chucks (not shown) or the like. Reticle stage RST can be finely driven within a horizontal plane (the XY plane), as well as scanned in the scanning direction (in this case, the Y-axis direction which is the landscape direction of the page surface in FIG. 6) by a reticle stage drive portion 48 within a range of predetermined strokes. The position of reticle stage RST during scanning is measured by an external laser interferometer 54R via a movable mirror 52R fixed on reticle stage RST, and measurement values of laser interferometer 54R are sent to main controller 50. An edge surface of reticle stage RST may be mirror-polished so as to form a reflection surface (corresponding to the reflection surface of movable mirror 52R) of laser interferometer 54R.

As projection optical system PL, for example, a double telecentric reduction system that is also a refraction system made up of a plurality of lens elements having a common optical axis AX in the Z-axis direction is used. In addition, projection magnification y of projection optical system PL is, for example, ¼ or ⅕. Therefore, when illumination area 42R of reticle R is illuminated with pulse illumination light IL in the manner previously described, a reduced image of the pattern formed on reticle R by projection magnification y is formed with projection optical system PL, on a slit-shaped exposure area (an area conjugate with illumination area 42R) 42W on wafer W which surface is coated with the resist (photosensitive agent).

XY stage 14 is driven two dimensionally in the XY surface by a wafer stage drive portion 56, in the Y-axis direction which is the scanning direction and the X-axis direction (the direction perpendicular to the page surface in FIG. 6) which is perpendicular to the Y-axis direction. On XY stage 14, a Z tilt stage 58 is mounted, and wafer W is held on Z tilt stage 58 by vacuum chucking or the like via a wafer holder (not shown). Z tilt stage 58 has the function of adjusting a position (focus position) of wafer W in the Z direction, as well as adjusting a tilt angle of wafer W with respect to the XY plane. In addition, the position of XY stage 14 is measured by an external laser interferometer 54W via a movable mirror 52W fixed on Z tilt stage 58, and measurement values of laser interferometer 54W are sent to main controller 50. An edge surface of Z tilt stage 58 (or XY stage 14) may be mirror-polished so as to form a reflection surface (corresponding to the reflection surface of movable mirror 52W) of laser interferometer 54W.

Furthermore, although it is omitted in the drawings, as is disclosed in detail in, for example, Japanese Patent Laid-open No. 07-176468 and the corresponding U.S. Pat. No. 5,646,413, a pair of reticle alignment microscopes that has image pick-up devices such as CCDs and uses light having an exposure wavelength (pulse illumination light IL in this embodiment) as illumination light for alignment based on an image processing method, are arranged above reticle R. In this case, the pair of reticle alignment microscopes is arranged symmetrical to the YZ plane including optical axis AX of projection optical system PL. In addition, the pair of reticle alignment microscopes is structured capable of moving back and forth along the X-axis direction within an XZ plane, which passes through optical axis AX. The above U.S. Patent disclosure is fully incorporated herein by reference.

Normally, the pair of reticle alignment microscopes is set at a position where a pair of reticle alignment marks arranged outside a light shielded area can each be observed, when reticle R is mounted on reticle stage RST.

As is shown in FIG. 6, the control system is structured with main controller 50 serving as a controller playing the main role. Main controller 50 is configured including a so-called microcomputer (or a minicomputer) made up of components such as a CPU (chief processing unit), a ROM (Read Only Memory), a RAM (Random Access Memory), and the like. Main controller 50 has total control over, for example, synchronous scanning of reticle Rand wafer W, stepping operations of wafer W, exposure timing, and the like so that the exposure operation is accurately performed.

More specifically, for example, during scanning exposure, main controller 50 controls each of the position and the velocity of reticle stage RST and XY stage 14 via reticle stage drive portion 48 and wafer stage drive portion 56, respectively, based on the measurement values of the laser interferometers 54R and 54W, so that when reticle R is scanned via reticle stage RST in the +Y direction (or −Y direction) in a velocity V_{R}, wafer W is synchronously scanned via XY stage 14 with respect to exposure area 42W in the −Y direction (or +Y direction) in a velocityγ·V_{R} (γ is the projection magnification from reticle R to wafer W). In addition, when stepping operations are performed, main controller 50 controls the position of XY stage 14 via wafer stage drive portion 56 based on the measurement values of laser interferometer 54W. As can be seen from the description above, main controller 50, laser interferometers 54R and 54W, reticle stage drive portion 48, wafer stage drive portion 56, reticle stage RST, and XY stage 14 make up a drive system in this embodiment.

In addition, by supplying control information TS to excimer laser light source 16, main controller 50 controls the emission timing, the emission power, and the like in excimer laser light source 16. Main controller 50 also controls rough energy adjuster 20 and illumination system aperture stop 24 via motor 38 and drive unit 40, respectively, and furthermore controls open/close operations of movable reticle blind 30B in sync with operation information on the stage system. As can be seen, in the embodiment, main controller 50 also plays the role of a dose control unit and a stage control unit. It is a matter of course, that these control units may be arranged separately, apart from main controller 50.

Next, an example of a connection procedure of exposure apparatus main body STP and light source unit 16 will be described.

When connecting exposure apparatus main body STP and light source unit 16, first of all, for example, height adjustment is performed on XY stage 14 (or the wafer holder) so that its height from the floor surface is at a predetermined height and is almost parallel to a horizontal plane, with respect to exposure apparatus main body STP arranged at a predetermined position within the clean room. Then, when the adjustment is completed, exposure apparatus main body STP and beam matching unit BMU are mechanically connected. When exposure apparatus main body STP and beam matching unit BMU are connected, for example, by matching the position of reference marks provided in advance in both connection portions, mechanical position setting between exposure apparatus main body STP and beam matching unit BMU is performed. And, after the mechanical position setting between exposure apparatus main body STP and beam matching unit BMU is completed, beam matching unit BMU and light source unit 16 are mechanically connected. Likewise, in this case, for example, by matching the position of reference marks provided in advance in both connection portions, mechanical position setting between beam matching unit BMU and light source unit 16 is performed.

When exposure apparatus main body STP, beam matching unit BMU, and light source unit 16 have been mechanically connected, then, the alignment of these optical paths, that is, optical axis adjustment is performed. Optical axis adjustment is performed based on the detection results of the first photodetector 61 arranged near opening 83a of light source unit 16 and the second photodetector 63 arranged in illumination unit IU, respectively.

First of all, posture control unit 600, referred to earlier, moves unit 300, 400, and 500 inside housing 83 of light source unit 16 based on the detection results of the first photodetector 61 arranged near opening 83a of housing 83, and controls their position and posture. With this operation, the shift in the optical axis of laser beam LB is adjusted so that laser beam LB passes through opening 83a of housing 83 without fail.

Next, optical axis adjustment is performed based on the detection results of the second photodetector 63. On this optical axis adjustment, two types of optical axis adjustment are performed; optical axis adjustment by posture control unit 600, and optical axis adjustment by beam matching unit BMU.

That is, first of all, posture control unit 600, referred to earlier, moves unit 300, 400, and 500 inside housing 83 of light source unit 16 based on the detection results of the second photodetector 63 arranged in illumination unit IU, and controls their position and posture. In the embodiment, as is previously described, the second photodetector 63 is arranged on the incident surface side of fly-eye lens 22, and based on the detection results of the second photodetector 63 control unit 82 controls each of the actuators within posture control unit 600. With this operation, the optical axis of laser beam LB is adjusted with respect to the reference position of the optical axis set in illumination unit IU.

In the operation that follows, main controller 50 controls the position and posture of parallel plate glasses 64a, 64b, and movable mirror 68 based on the detection results of the second photodetector 63. Likewise, with this operation, the optical axis of laser beam LB is adjusted within a predetermined range, with respect to the reference position of the optical axis set in illumination unit IU.

With the optical axis adjustment by posture control unit 600, since it is performed at a position optically further away from the reference position when compared to the optical axis adjustment by beam matching unit BMU, the optical axis can be adjusted in a broader range with little control amount. On the contrary, the optical axis adjustment by beam matching unit BMU is performed at a position optically closer to the reference position than when the optical axis adjustment is performed by posture control unit 600, therefore, although the adjustment range is relatively narrow, a more precise optical axis adjustment can be performed. Accordingly, by combining a relatively rough optical axis adjustment by posture control unit 600 and a relatively fine optical axis adjustment by beam matching unit BMU, a precise optical adjustment can be performed within a short period. In addition, even when exposure apparatus main body STP and light source unit 16 are arranged on different floors, or an obstacle is arranged in between the two units, optical axis adjustment can be easily performed, based on the detection results of the second photodetector 63. Incidentally, the order of performing the optical adjustments by posture control unit 600 and beam matching unit BMU is not limited to the order referred to above. That is, the above order may be reversed, or the adjustments may be performed alternately, when necessary.

When optical axis adjustment with exposure apparatus main body STP, beam matching unit BMU, and light source unit 16 has been completed, then, for example, measurement unit 500 of light source unit 16 measures properties (optical properties) of laser beam LB such as wavelength, profile, and energy, and based on the measurement results controls an adjustment mechanism within wavelength narrow bandwidth unit 400 in light source 16 and illumination unit IU. In this case, since the optical axis of laser beam LB from light source unit LB is precisely adjusted in prior, the above optical properties are precisely adjusted. When an operation other than optical axis adjustment is performed using measurement unit 500, such as adjustment on the optical properties of laser beam LB, the process does not have to be performed only after all optical axis adjustments but may be performed when at least optical axis adjustment by posture control unit 600 is completed. That is, in this case, operations may be in the following order: optical axis adjustment by posture control unit 600→adjustment of optical properties→optical axis adjustment by beam matching unit BMU. In addition, light source unit 16 is fixed to its arrangement surface (such as floor surface F). The light source unit 16 may be fixed at any timing, such as before the above adjustment and measurement, or after the optical adjustment by posture control unit 600.

By following the procedures described above, exposure apparatus main body STP and light source unit 16 can be optically connected via beam matching unit BMU.

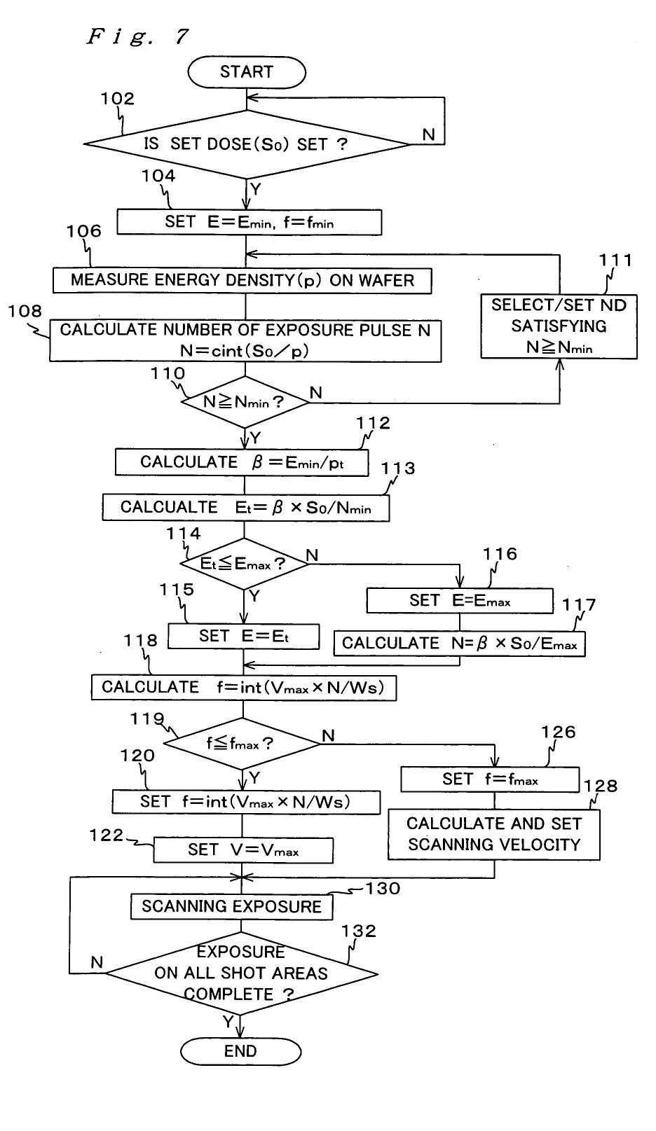

Next, a basic dose control sequence of scanning exposure apparatus 10 in the embodiment, which is performed after optical axis adjustment and other adjustments on the optical properties of laser beam LB have been completed in the manner above, is described referring to a flow chart in FIG. 7 that shows a control algorithm of the CPU in main controller 50.

In actual, output DS of integrator sensor 46 is calibrated in advance with respect to a reference illuminometer (not shown) arranged on Z tilt stage 58 in FIG. 6 at the same height as the image plane (that is, the surface of the wafer), which allows a transformation coefficient α indicating the relation between the image plane illuminance and the output of integrator sensor 46 to be obtained with each illumination condition (dose distribution of illumination light IL on the pupil plane of the illumination optical system). And, prior to exposure, by using integration sensor 46 and beam monitor 504 (energy monitor) within excimer laser light source 16, a predetermined control table is made that indicates dosage on the image plane indirectly obtained by transformation coefficient α in each illumination condition and output DS of integrator sensor 46, or in other words, indicates a correlation between process amount p (mJ/(cm²·pulse)) of integrator sensor 46 and output ES (mJ/pulse) of beam monitor 504 (energy monitor) inside excimer laser light source 16.

However, in the description that follows, for the sake of simplicity, the correlation between integrator sensor 46 and beam monitor 504 (energy monitor) is described as a linear function, and its offset can be considered 0 whereas the tilt can serve as transformation coefficient β. That is, an assumption can be made that output ES (mJ/pulse) of beam monitor 504 (energy monitor) can be calculated by the following equation, using process amount p (mJ/(cm²·pulse)) of integrator sensor 46 and transformation coefficient β.
ES=β·p (3)

When the optical unit previously described is provided, it is preferable to obtain above transformation coefficient β by each incident condition of illumination light on optical integrator 22, which varies due to the optical unit. In addition, it is preferable to update transformation coefficients α and β by calculation, taking into account the transmittance change of illumination light IL in the illumination optical system that makes up the illumination system 12 and in projection optical system PL.

In addition, in order to minimize the exposure time in the overall set dose, the transmittance of rough energy adjuster 20, that is, the discrete transmittance is to be designed in geometric progression.

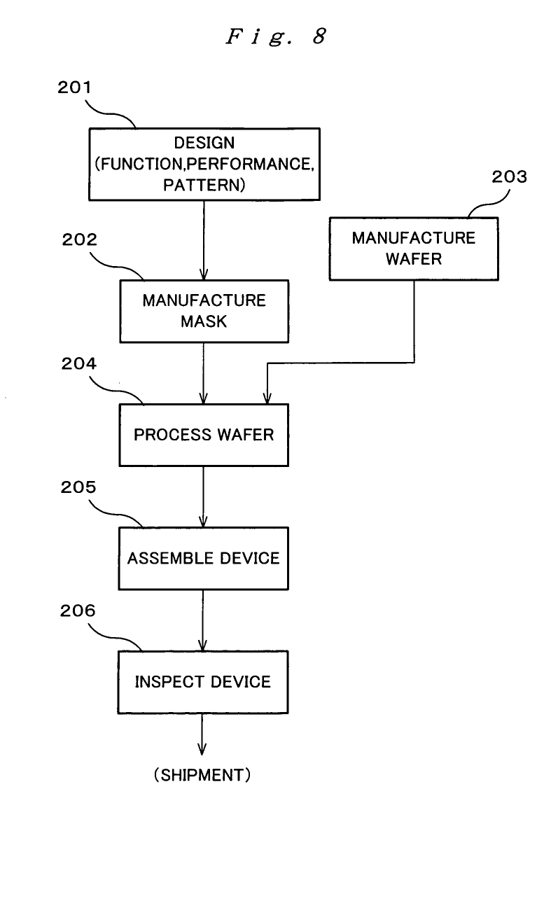

First, in step 102 in FIG. 8, an operator sets set dose S₀ via an input/output device 62 (refer to FIG. 6) such as a console. When set dose S₀ is set, the sequence then proceeds to the next step 104, and the energy per pulse E of laser beam LB is set to the minimum energy value Eₘᵢₙ (8 mJ/pulse), and the repetition frequency f set to the minimum frequency fₘᵢₙ (600 Hz). That is, in this manner, the pulse energy and repetition frequency are set in neutral.

In the next step, step 106, excimer laser light source 16 performs pulse emission a plurality of times (for example, a hundred times), and by adding up the output of integrator sensor 46, an average pulse energy density p (mJ/(cm²·pulse)) on wafer W is indirectly measured. The measurement is performed, for example, in a state where movable reticle blind 30B is driven so that its aperture is completely closed to prevent illumination light IL from reaching the reticle R side. As a matter of course, the measurement may be performed in a state where wafer W is withdrawn by driving XY stage 14.

In the next step, step 108, the number of exposure pulse N is calculated by equation (4) below.
N=cin t(S₀/p) (4)

Function cin t shows that the value after the decimal point is rounded off.

In the next step, step 110, the number of exposure pulse N is checked to see whether it is greater than a minimum exposure pulse number Nₘᵢₙ, which is necessary to obtain a required level of dose control repeatability precision. In this case, minimum exposure pulse number Nₘᵢₙ is a value that can be obtained, for example, based on a ratio δₚ/p, which is a ratio of a pulse energy dispersion (a 3σ value) δₚ measured in advance and set as an apparatus constant to the average pulse energy density p. In the embodiment, for example, Nₘᵢₙ=40.

And, when the decision in step 110 turns out to be negative, that is, when the number of exposure pulse N is less than the minimum exposure pulse number Nₘᵢₙ, the sequence then proceeds to step 111, and from the transmittance that can be set by the ND filters of rough energy adjuster 20 in FIG. 6, the ND filter which transmittance is smaller but closest to S₀/(Nₘᵢₙ×p) is selected and set. Step 106 is then repeated, and the average pulse energy density under the selected ND conditions p=pₜ is newly obtained. And, using the average pulse energy density pₜ, the process in step 108 is repeated. In this manner, when the decision instep 110 turns out positive, or is positive from the beginning (that is, when N is equal to or greater than Nₘᵢₙ, N≧Nₘᵢₙ), the sequence then moves on to step 112. When the decision in step 110 is positive from the beginning, since the average pulse energy density p satisfies N≧Nₘᵢₙ likewise the average pulse energy density pₜ under the selected ND conditions, it will hereinafter be referred to as pₜ.

In step 112, transformation coefficient β mentioned above is calculated based on equation (5) below, using energy density pₜ obtained in step 106. As a matter of course, the calculation method is not limited to this, and when the above control table is prepared in advance, transformation coefficient β corresponding to the average pulse energy density pₜ can be calculated from the control table.
β=Eₘᵢₙ/pₜ (5)

In the next step, step 113, by equation (6) that follows, an energy set value Eₜ (mJ/pulse) per pulse of laser beam LB is calculated, and then the sequence moves on to step 114.
Eₜ=β×S₀/Nₘᵢₙ (6)

In step 114, a decision is made of whether the above energy set value Eₜ is below the maximum energy Eₘₐₓ (in this case, 10 mJ/pulse) that can be set or not. When the decision turns out to be positive, then the sequence proceeds to step 115, where energy set value Eₜ is supplied to control unit 82 previously described, and then to step 118. By this operation, control unit 82 sets the value Eₜ as the energy per pulse E.

On the other hand, when the decision in step 114 results negative, that is, when energy set value Et is larger than the maximum energy Eₘₐₓ that can be set, since such energy setting is not possible the sequence proceeds to step 116 so as to supply Eₜ=Eₘₐₓ as the energy set value to control unit 82. By this operation, control unit 82 sets the value Eₘₐₓ as the energy per pulse E.

In this case, since N is not equal to Nₘᵢₙ, the sequence then proceeds to step 117 to calculate the number of exposure pulse N according to equation (7) below, and then moves on to step 118.
N=β×S₀/Eₘₐₓ (7)

In step 118, repetition frequency f is calculated by equation (8) that follows, with scanning velocity V as scanning maximum velocity (Vₘₐₓ).
f=int(Vₘₐₓ×N/Ws) (8)

Function int(a) expresses a maximum integer that does not exceed a real number a.

And in the next step, step 119, a decision is made of whether repetition frequency f calculated above is below a maximum repetition frequency fₘₐₓ of the laser or not. If the decision results positive, then the sequence proceeds to step 120 and repetition frequency f is set to the value calculated above via control unit 82, and in the next step, step 122, a scanning target velocity (the scanning velocity) is set at scanning maximum velocity Vₘₐₓ.

Meanwhile, when the decision in step 119 turns out to be negative, since repetition frequency f cannot be set to the above calculated value, the sequence then proceeds to step 126. In step 126, repetition frequency f is set at the maximum oscillation frequency fₘₐₓ via control unit 82, and the sequence proceeds to step 128 so that scanning velocity V is set, based on the following equation, (9).
V=Ws×fₘₐₓ/N (9)

Finally, in step 130, under the set conditions set in the earlier steps (V, f, E, and N), the pattern of reticle R is transferred onto the designated shot area on wafer W, based on a scanning exposure method.

When the above scanning exposure is completed, in step 132, a decision of whether exposure on all shot areas have been completed or not, and if the decision is negative, that is when there are still shot areas to be exposed, the sequence then returns to step 130 so that scanning exposure is performed on the next shot area.

When exposure process on all the shot areas that should be exposed has been completed in the manner above, it completes the series of processing in the present routine.

In addition, although it is not specifically described above, in the embodiment, prior to beginning exposure, reticle alignment is performed with the pair of reticle alignment microscopes earlier described that uses pulse illumination light IL as the alignment light. In the reticle alignment, an image of a pair of reticle alignment marks (not shown) on reticle R and an image of fiducial marks for reticle alignment formed on a fiducial mark plate (not shown) on XY stage 14 via projection optical system PL are observed at the same time through the reticle alignment microscopes, and the positional relationship between both mark images measured. Then, main controller 50 obtains the projection position of the reticle pattern image, based on the measured positional relationship and the measurement values of reticle interferometer 54R and wafer interferometer 54W when the above measurement was performed. Main controller 50 can preferably vary the neutral setting of pulse energy and its repetition frequency of excimer laser light source 16 on reticle alignment from the setting during scanning exposure previously described, when necessary, depending on stability properties of pulse emission in excimer laser light source 16.

According to experiments performed by the inventors, in the conventional case when pulse energy is fixed at 10 (mJ/pulse), the measurement result of energy on the image surface was p=0.8(mJ/cm²/pulse), and it has been confirmed that attenuation by ND filters is required if set dose S₀ is smaller than S₀=0.8×40=32(mJ/cm²). Whereas, when pulse energy is set at 8 (mJ/pulse) as in the embodiment, the measurement result of energy on the image plane using the same optical system was p=0.64(mJ/cm²/pulse), and it has been confirmed that attenuation by ND filters is not required until set dose S₀ reaches the range of S₀=0.64×40=25.6(mJ/cm²). That is, such an arrangement broadened a non-attenuation area.

In addition, when dose control is performed in the conventional dose control method with set dose S₀ being S₀=22(mJ/cm²), when pulse energy is fixed at 10 (mJ/pulse), the measurement result of energy on the image surface was p=0.8(mJ/cm²/pulse), and the number of exposure pulse N was N=cint(S₀/p)=28<Nₘᵢₙ=40. Therefore, energy p on the image plane and the number of exposure pulse N were re-measured, this time with an ND filter having a transmittance of 58% set on the optical path. The results were p=0.464 (mJ/cm²/pulse) and N=47. And, after fine energy adjustment, energy set value Eₜ was set at Eₜ=S₀/N/p×10=10.09(mJ/pulse).

On the other hand, when dose control is performed in the dose control method in the embodiment with the same set dose S₀ of S₀=22 (mJ/cm²), with pulse energy Eₘᵢₙ=8 (mJ/pulse) the energy on the image plane was p=0.64 (mJ/cm²/pulse) and the number of exposure pulse N=cint(S₀/p)=34<Nₘᵢₙ=40. Therefore, energy p on the image plane and the number of exposure pulse N were re-measured, this time with an ND filter having a transmittance of 80% set on the optical path. The results were p=0.512(mJ/cm²/pulse) and N=43. And, when energy adjustment was performed with N=Nₘᵢₙ=40, energy set value Eₜ was finally set at E_{t=β·p}ₜ=S₀/Nₘᵢₙ/p×8=8.59 (mJ/pulse). Accordingly, in this case, the number of pulse has been reduced from 47 to 40, and pulse energy reduced from 10.09 mJ to 8.59 mJ.

As is described in detail so far, with the light source unit adjustment method performed by exposure apparatus 10 in the embodiment, it includes the process of moving the units inside housing 83 of light source unit 16 and performing optical axis adjustment. Therefore, by moving the units inside housing 83, the optical axis can be made to fall within an adjustable range by beam matching unit BMU, even if the shift in the optical axis exceeds the adjustable range by beam matching unit BMU. This allows beam matching unit BMU to perform accurate optical axis adjustment in a simple manner. More particularly, even when exposure apparatus main body STP and light source unit 16 are arranged optically far apart, optical axis adjustment can be performed with little workload. In this case, even when the position of exposure apparatus main body STP and light source unit 16 shift with the elapse of time, the adjustment method in the embodiment can be suitably applied. Furthermore, since only the units that need to be moved are moved in housing 83, the weight of the objects moved is light. Moreover, when the optical axis adjustment is performed, since it is possible to move units only in housing 83 in directions of five degrees of freedom, control is simpler and easier than when optical axis adjustment is performed by controlling the posture of the optical elements of laser beam LB emitted from light source 16. In this case, the mechanical connection between light source unit 16 (housing 83) and beam matching unit BMU can also be maintained without any changes, thus optical axis adjustment can be performed with little workload.

In addition, with scanning exposure apparatus 10 and the dose control method during scanning exposure related to the embodiment, in a range corresponding to a high sensitivity resist, exposure at scanning maximum velocity (Vₘₐₓ) is possible at all times (regardless of set dose S₀) without being affected by the discrete attenuation ratio of rough energy adjuster 20, reducing exposure time to a minimum. In addition, also in a range corresponding to a low sensitivity resist, exposure time can be reduced as much as possible, since exposure is performed at the maximum repetition frequency fₘₐₓ and the maximum pulse energy Eₘₐₓ of excimer laser light source 16. That is, even as a broad set exposure range throughput, it is possible to obtain a maximum performance.

Furthermore, in the embodiment, in the high sensitivity range where exposure is performed at scanning maximum velocity Vₘₐₓ, since exposure in the minimum exposure pulse Nₘᵢₙ is possible at all times, the number of consumed pulses is reduced to the minimum, making cost reduction possible. In this case, since a desirable dose repeatability precision can be secured, dose control with high precision is possible. In addition, since energy consumption in excimer laser light source 16 can be suppressed, gas consumption, power consumption, and furthermore a life-extending effect can be expected since the load onto excimer laser light source 16 and the optical elements in illumination system 12 can be decreased. That is, because the glass material in illumination system 12 degrades in proportion with the number of laser pulse and the amount of pulse energy, in the embodiment, the life of the glass material can be extended since the number of laser pulse is reduced and the pulse energy incident on the ND filter (attenuator) is also reduced.

In addition, in the conventional method the output of the excimer laser light source was fixed to around Eₘₐₓ, however, with the embodiment, since the pulse energy of excimer laser light source 16 can be changed, the energy on the image plane per pulse can be relatively low, which broadens the non-attenuation area that does not require attenuation with units such as rough energy adjuster 20. In other words, with respect to the same set dose, the ND filter with a lower attenuation than the one used in the conventional method can be used in the embodiment, which leads to suppressing energy loss.

Furthermore, in the embodiment, since the pulse energy of excimer laser light source 16 is changed, dose of laser beam LB with respect to wafer W can be controlled at a high speed with high precision, and a desired total dose can be obtained at each point on wafer W.

The present invention, however, is not limited to this, and instead of pulse energy change, or with the pulse energy change, it is a matter of course that the energy density given to the image plane can be changed by using an energy modulator that can continuously change the transmittance of the laser beam. In such a case, for example, the energy modulator is arranged on the optical path of laser beam LB in between rough energy adjuster 20 and fly-eye lens 22 in FIG. 6, and main controller 50 controls the energy modulator so that a desired total dose can be obtained at each point on wafer W. As the energy modulator in this case, for example, on the optical path of the pulse emitted laser beam LB, a modulator based on a double grating method can be used that has a fixed grid plate on which a transmitting portion and a shielding portion is formed at a predetermined pitch and a movable grid plate that can move freely in the pitch direction of the grating. By shifting the relative position of the two grid plates, transmittance with respect to laser beam LB can be modulated. Details on modulation based on such a double grating method are disclosed in, for example, Japanese Patent Laid-open No. 03-179357 and the corresponding U.S. Pat. No. 5,191,374. The disclosure of the U.S. Patent cited above is fully incorporated herein by reference.

In addition, when the image plane illuminance changes due to a change in illumination conditions, the exposure conditions during scanning exposure, which was described earlier, have to be reset. This is because, when illumination conditions are changed, the dose distribution (the size and shape of the secondary light source) of the illumination light on the pupil plane of the illumination optical system is also changed, resulting in a high possibility of a change in average energy per pulse p on the image plane or in transformation coefficients α and β described earlier or the like.

In the above embodiment, the case has been described where an excimer laser light source is used as the pulse light source and main controller 50 changes the pulse energy by controlling the power supply voltage (Hv) in laser power supply (high voltage power supply) 308 within laser excimer light source 16 and gas pressure of gases such as rare gas (Kr) and halogen (F₂) in the excimer laser tube, however, the present invention is not limited to this. For example, since there is some kind of a correlation existing between a temperature of laser gas or a state of other gases and the energy per pulse emitted from excimer laser light source 16, such a relation can be used to change the pulse energy of excimer laser light source 16. In short, the pulse energy may be changed, by controlling a predetermined control factor (the above power supply voltage and gas states are included in the factor) related to oscillation of excimer laser light source 16. Even when a laser light source other than an excimer laser light source is used as the laser light source, the pulse energy can be changed, by controlling control factors related to oscillation (or pulse emission) of the laser light source.

Furthermore, in the embodiment, since the pulse energy of excimer laser light source 16 is changed, the relationship between the energy (or the set energy) per pulse of the output of excimer laser light source 16 and the predetermined control factors (control parameters) such as the power supply voltage (Hv) in laser power supply 308 and gas pressure of gases such as rare gas (Kr) and halogen (F₂) is preferably obtained in advance, and for example, when pulse emission pauses and starts again, the above relationship is preferably updated sequentially in a learning table (a so-called downtime learning table) by each set energy, based on the values detected by beam monitor 504 (energy monitor). With such an arrangement, even if the set energy changes in the same downtime, an optimum pulse energy control is possible without being influenced by the change. The downtime learning table may also be created by each downtime.

In addition, scanning maximum velocity Vₘₐₓ in the embodiment is the limit maximum velocity (the upper limit value) due to the configuration of reticle stage drive system including the thrust of the linear motor driving reticle stage RST, however, for example, when reticle stage RST is moved at the upper limit value and it is difficult to satisfy the required synchronous accuracy between reticle stage RST and wafer stage WST, scanning maximum velocity Vₘₐₓ can be set at a velocity of reticle stage RST smaller than the upper limit value from the synchronous accuracy. That is, scanning maximum velocity Vₘₐₓ is not restricted by the limit maximum velocity structurally.

In the embodiment, since projection optical system PL is a reduction system (magnification γ) and during scanning exposure the movement velocity of reticle stage RST becomes a reciprocal number of times (1/γ) the projection magnification of wafer stage WST, it is described in the description that reticle stage RST reaches the limit maximum velocity before the wafer stage. However, when wafer stage WST reaches the limit maximum velocity before reticle stage RST, the exposure may be set so that not reticle stage RST but wafer stage WST moves at scanning maximum velocity Vₘₐₓ in the high sensitivity range. In addition, in the embodiment, main controller 50 controls the pulse energy, the number of repetition frequency, and the like by sending out instructions (control information) to excimer laser light source 16. For example, however, main controller 50 may only give out information related to the minimum exposure pulse number and the output of integrator sensor, and the pulse energy and the number of repetition frequency may be decided by the control unit in excimer laser light source 16. Furthermore, in the embodiment the repetition frequency is variable in excimer laser light source 16, however, there may be cases when pulse oscillation cannot be performed due to reasons such as a large change in pulse energy in specific frequencies. In such a case, exposure conditions (such as scanning velocity, repetition frequency, and pulse energy) are preferably set taking into account such specific frequencies. In the case of using a laser light source based on an injection-locking method, since the possibility of such inconvenience occurring is low, it maybe used in the embodiment.

Incidentally, in the embodiment above, parallel plate glasses and a movable mirror are used as a means for adjusting the optical properties with the beam matching unit. The present invention, however, is not limited to this, and means such as a deflection prism, a zoom lens, and a zoom expander may also be used. In this case, the shape and size of the laser beam can also be adjusted. The light source unit in the present invention, however, has an advantage, because since it has a unit that controls the posture of the units inside the housing, the number of such optical elements used for adjustment within the beam matching unit can be reduced. Especially, when the wavelength of the illumination light becomes shorter, tighter control on impurities in the space enclosing the optical path is necessary; therefore, it is advantageous from the controlling point of view when less optical members move on the optical path. In addition, apart of, or all of the optical members for adjustment conventionally arranged in the beam matching unit may be arranged inside the housing of the light source unit. Also, the beam matching unit may be made up of a plurality of connected parts, so that the positional relationship between the parts may vary.

In addition, in the above embodiment, units 300, 400, and 500 within housing 83 are structured movable in directions of five degrees of freedom, however, the present invention is not limited to this, and they may be structured movable in directions of four degrees of freedom, or in directions of six degrees of freedom. In any case, the units may be preferably structured so that they can at least move in directions that narrow the adjustment range in the beam matching unit. In addition, in the above embodiment, on optical axis adjustment, laser oscillation unit 300, wavelength narrow bandwidth unit 400, and measurement unit 500 housed in housing 83 were moved altogether, however, measurement unit 500 does not necessarily have to be moved. Also, when the light source unit does not comprise the wavelength narrow bandwidth unit, only at least the laser oscillation unit has to be moved. That is, the drive unit that drives at least one of a plurality of units that make up the light source unit in the present invention may have any structure, so long as it can adjust, for example, the position and posture of the laser oscillation unit.

In addition, in the above embodiment, the photodetectors serving as measurement units that measure the positional information related to the position of the optical axis are arranged at two places, close to the opening of the housing in the light source unit and on the incident surface side of the fly-eye lens in the illumination optical system, however, the arrangement position and the number of places to arrange the photodetectors may be arbitrary. Furthermore, the photodetector(s) may be structured so that it measures the optical axis position indirectly by measuring the posture of a casing including the optical system and the like, and not detecting the light directly. In addition, in the exposure apparatus that comprises the light source unit (FIG. 2) in the above embodiment, one end of beam matching unit BMU is connected to light source unit 16, and then when the other end is connected to the exposure apparatus (illumination unit), the optical axis adjustment by posture control unit 600 previously described and the adjustment on the optical properties by measurement unit 500 are performed. Furthermore, operations such as the optical axis adjustment by beam matching unit BMU, adjustment on various optical systems by projection optical system PL, and adjustment on various mechanical systems and electrical systems are performed, which completes the start up of the exposure apparatus in the clean room.

In the above embodiment, the case has been described where the present invention is applied to a scanning exposure apparatus based on a step-and-scan method. The present invention, however, is not limited to this, and it maybe suitably applied to any type of scanning type exposure such as an exposure apparatus based on a slit-scan method.

In addition, the usage of the exposure apparatus in the present invention is not limited to exposure apparatus used for manufacturing semiconductors, and for example, can be broadly applied to an exposure apparatus for manufacturing crystal displays used to transfer crystal display device patterns onto a square-shaped glass plate, and an exposure apparatus for manufacturing display units such as a plasma display or an organic EL display, a thin film magnetic head, a micromachine, a DNA chip, or the like. In addition, the present invention can also be applied to an exposure apparatus used not only for manufacturing semiconductor devices such as a microdevice, but also to an exposure apparatus used for manufacturing a mask or a reticle used in an optical exposure apparatus, an EUV exposure apparatus, an X-ray exposure apparatus, an electron beam exposure apparatus, and the like, in order to transfer a circuit pattern onto a glass substrate or a silicone wafer.

In addition, in the above embodiment, as the laser beam, a harmonic may be used, which is obtained by amplifying a single-wavelength laser beam in the infrared or visible range emitted by a DFB semiconductor laser or fiber laser, with a fiber amplifier doped with, for example, erbium (or both erbium and ytteribium), and by converting the wavelength into ultraviolet light using a nonlinear optical crystal.

If, for example, the oscillation wavelength of a single-wavelength laser is set within the range of 1.51 to 1.59 μm, an eighth-harmonics whose generation wavelength falls within the range of 189 to 199 nm or a tenth-harmonics whose generation wavelength falls within the range of 151 to 159 nm is output. If the oscillation wavelength is set in the range of 1.544 to 1.553 μm, in particular, an eighth-harmonics whose generation wavelength falls within the range of 193 to 194 nm, that is, ultraviolet light having almost the same wavelength as that of an ArF excimer laser beam can be obtained. If the oscillation wavelength is set within the range of 1.57 to 1.58 μm, a tenth-harmonics whose generation wavelength falls within the range of 157 to 158 nm, that is, ultraviolet light having almost the same wavelength as that of an F₂ laser beam can be obtained.

If the oscillation wavelength is set within the range of 1.03 to 1.12 μm, a seventh-harmonics whose generation wavelength falls within the range of 147 to 160 nm is output. If the oscillation wavelength is set within the range of 1.099 to 1.106 μm, in particular, a seventh-harmonics whose generation wavelength falls within the range of 157 to 158 μm, that is, ultraviolet light having almost the same wavelength as that of an F₂ laser beam, can be obtained. In this case, as a single-wavelength oscillation laser, for example, an ytteribium-doped fiber laser can be used.

In addition, as the laser light source, a light source that emits light in the vacuum ultraviolet region such as a Kr₂ laser (a krypton dimer laser) having a wavelength of 146 nm, an Ar₂ laser (argon dimer laser) having a wavelength of 126 nm may be used as the light source. Furthermore, by using an SOR or a laser plasma light source as the laser light source, a EUV light in the soft X-ray region may be used as illumination light IL.

In addition, the projection optical system is not limited to a reduction system, and an equal magnification system and an enlarged magnification system may also be used. Likewise, the projection optical system is not limited to a refraction system, and a reflection refraction system as well as a reflection system may also be used.

In addition, when linear motors are used for the above XY stage and reticle stage, the linear motors used may either be an air levitation type using air bearings or a magnetic levitation type using the Lorentz force or the reactance force. Also, the stages may be of the type that moves along a guide, or a guideless type that moves without a guide. Furthermore, when planar motors are used as the stage drive systems, either one of a magnet unit (a permanent magnet) or an armature unit may be connected to the stage, while the other remaining unit of the above units may be provided on the movement surface side (supporting bed, base) of the stage.

The reaction force generated by the movement of the XY stage may be mechanically released to the floor (ground) using a frame member, as is disclosed, for example, in Japanese Patent Laid Open No. 08-166475 and the corresponding U.S. Pat. No. 5,528,118. The U.S. Patent cited above is fully incorporated by reference herein.

And, the reaction force generated by the movement of the reticle stage may be mechanically released to the floor (ground) using a frame member, as is disclosed, for example, in Japanese Patent Laid Open No. 08-330224 and the corresponding U.S. Pat. No. 5,874,820. The U.S. Patent cited above is fully incorporated by reference herein.

In addition, the exposure apparatus in the present invention is made, by assembling various subsystems that include each of the component elements referred to in the claims so that they maintain a predetermined mechanical accuracy, electrical accuracy, and optical accuracy. In order to secure such accuracy of various kinds, the following adjustment operations are performed before and after the assembly: adjustment on each of the optical systems to achieve the optical accuracy, adjustment on each of the mechanical system to achieve the mechanical accuracy, and adjustment on each of the electric systems to achieve the electrical accuracy. The assembly process of building the various subsystems into the exposure apparatus includes operations such as mechanical connection, wiring connection of electric circuits, and piping connection of pressure circuits in between the various subsystems. It is a matter of course, that before the assembly process of building the various subsystems into the exposure apparatus, each of the subsystems are to be individually assembled. And, when the assembly process of building the various subsystems into the exposure apparatus is completed, total adjustment is performed and the accuracy of various kinds are secured in the exposure apparatus as a whole. Incidentally, the exposure apparatus is preferably made in a clean room where conditions such as the temperature and the degree of cleanliness are controlled.

<<Device Manufacturing Method>>

An embodiment of a device manufacturing method using the exposure apparatus above in a lithographic process is described next.

FIG. 8 is a flow chart showing an example of manufacturing a device (a semiconductor chip such as an IC or LSI, a liquid crystal panel, a CCD, a thin magnetic head, a micromachine, or the like). As shown in FIG. 8, in step 201 (design step), function/performance is designed for a device (e.g., circuit design for a semiconductor device) and a pattern to implement the function is designed. In step 202 (mask manufacturing step), a mask on which the designed circuit pattern is formed is manufactured. Instep 203 (wafer manufacturing step), a wafer is manufacturing by using a silicon material or the like.

In step 204 (wafer processing step), an actual circuit and the like is formed on the wafer by lithography or the like using the mask and wafer prepared in steps 201 to 203, as will be described later. Next, in step 205 (device assembly step) a device is assembled using the wafer processed in step 204. The step 205 includes processes such as dicing, bonding, and packaging (chip encapsulation), as necessary.

Finally, in step 206 (inspection step), a test on the operation of the device, durability test, and the like are performed. After these steps, the device is completed and shipped out.

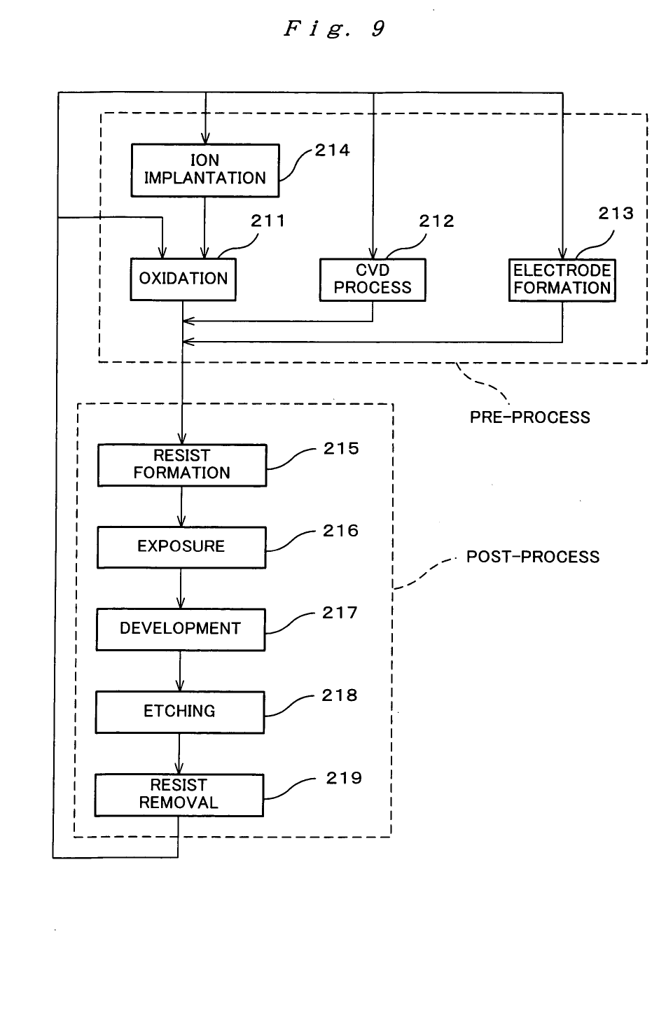

FIG. 9 is a flow chart showing a detailed example of step 204 described above in manufacturing the semiconductor device. Referring to FIG. 9, in step 211 (oxidation step), the surface of the wafer is oxidized. In step 212 (CVD step), an insulating film is formed on the wafer surface. In step 213 (electrode formation step), an electrode is formed on the wafer by vapor deposition. In step 214 (ion implantation step), ions are implanted into the wafer. Steps 211 to 214 described above constitute a pre-process for the respective steps in the wafer process and are selectively executed based on the processing required in the respective steps.

When the above pre-process is completed in the respective steps in the wafer process, a post-process is executed as follows. In this post-process, first, in step 215 (resist formation step), the wafer is coated with a photosensitive agent. Next, as in step 216, the circuit pattern on the mask is transferred onto the wafer by the exposure apparatus described in the embodiment. Then, in step 217 (developing step), the exposed wafer is developed. In step 218 (etching step), an exposed member of an area other than the area where the resist remains is removed by etching. Finally, in step 219 (resist removing step), when etching is completed, the resist that is no longer necessary is removed.

By repeatedly performing these pre-process and post-process steps, multiple circuit patterns are formed on the wafer.

When using the device manufacturing method described so far in the embodiment, since the exposure apparatus and the exposure method in the above embodiment are used in the exposure process (step 216), the reticle pattern can be transferred onto the wafer precisely by a highly precise dose control. Consequently, productivity of high integration devices (including yield) can be improved. In addition, especially in a high sensitivity range, wasteful pulse consumption can be prevented by exposure with the minimum exposure pulse number, which leads to suppressing power consumption and extends the life of the pulse light source and optical system since the load on the pulse light source and optical system is reduced. Accordingly, the productivity can be improved from another aspect; cost.

While the above-described embodiments of the present invention are the presently preferred embodiments thereof, those skilled in the art of lithography systems will readily recognize that numerous additions, modifications, and substitutions may be made to the above-described embodiments without departing from the spirit and scope thereof. It is intended that all such modifications, additions, and substitutions fall within the scope of the present invention, which is best defined by the claims appended below.

1. An adjustment method of a light source unit that adjusts optical properties of light emitted from said light source unit via an outgoing opening, said light source unit including a housing in which said outgoing opening for said light is formed and a plurality of units housed in said housing, and said adjustment method including:
adjusting an optical axis of said light by moving at least one unit of said plurality of units in said housing.

2. The adjustment method of said light source unit of claim 1 wherein information related to positional relationship between said outgoing opening of said housing and said optical axis of said light is measured when said optical axis is adjusted, and said optical axis is adjusted based on results of said measurement.

3. The adjustment method of said light source unit of claim 2, said adjustment method further including:
measuring information related to positional relationship between a reference position set in an optical system where said light emitted from said housing via said outgoing opening is incident and said optical axis of said light, and adjusting said optical axis based on results of said measurement.

4. The adjustment method of said light source unit of claim 1 wherein information related to positional relationship between a reference position set in an optical system where said light emitted from said housing via said outgoing opening is incident on and said optical axis of said light is measured when said optical axis is adjusted, and said optical axis is adjusted based on results of said measurement.

5. The adjustment method of said light source unit of claim 1, said adjustment method further including:
adjusting at least one of wavelength, profile, and energy of said light after said optical axis is adjusted.

6. An exposure method of illuminating a mask on which a pattern is formed with light from a light source unit that includes a housing in which an outgoing opening for said light is formed and a plurality of units are housed and transferring said pattern onto a photosensitive object, said exposure method including:
adjusting properties of said light emitted from said light source unit using an adjustment method of a light source unit of claim 1; and
transferring said pattern onto said photosensitive object by illuminating said mask with said light which properties are adjusted.

7. A device manufacturing method including a lithographic process, wherein in said lithographic process exposure is performed using said exposure method of claim 6.

8. A light source unit, said unit comprising:
a housing in which an outgoing opening where light is emitted is formed;
a plurality of units housed in said housing; and
a drive unit that moves at least one unit of said plurality of unit in said housing.

9. The light source unit of claim 8 wherein said drive unit moves at least one unit of said plurality of unit in said housing, based on information related to a position of an optical axis of light emitted from said housing.

10. The light source unit of claim 9, said unit further comprising at least one of:
a first measurement unit that measures information related to a positional relationship between said optical axis of said light and said outgoing opening of said housing, and
a second measurement unit that measures information related to a positional relationship between a reference position set in an optical system on which said light emitted from said housing is incident and said optical axis of said light.

11. The light source unit of claim 8 wherein
said plurality of units include an oscillation unit that oscillates said light, a measurement unit that measures at least one of wavelength, profile, and energy of said light, and a wavelength narrow bandwidth unit that narrows a wavelength bandwidth of light oscillated by said oscillation unit, and
said drive unit moves at least two units of said oscillation unit, said measurement unit, and said wavelength narrow bandwidth unit together inside said housing.

12. An exposure apparatus that transfers a pattern formed on a mask onto a photosensitive object, said exposure apparatus comprising:
a light source unit of claim 8;
an illumination optical system that guides light from said light source to said mask; and
a projection optical system that projects light emitted from said mask onto said photosensitive object.
